(19) United States
(12) Patent Application Publication
(10) Pub. No.: US 2026/0303013 A1
(43) Pub. Date: Oct. 1, 2026

(54) FLEXIBLE PEROVSKITE SOLAR CELL MODULE SHEET REPOWERING ASSEMBLY

(71) Applicant: Verde Technologies Incorporated, Burlington, VT (US)

(72) Inventors: Richards Galt Miller, III, Duxbury, VT (US); Vivek Babu, Essex Junction, VT (US)

(73) Assignee: Verde Technologies Incorporated, Burlington, VT (US)

(21) Appl. No.: 19/630,422

(22) Filed: Mar. 26, 2026

Related U.S. Application Data
(60) Provisional application No. 63/777,788, filed on Mar. 26, 2025.

(51) Int. Cl. H02S 30/20; H02S 20/30; H02S 40/36

(52) U.S. Cl. CPC H02S 30/20; H02S 20/30; H02S 40/36

(57) ABSTRACT

A solar cell module repowering assembly comprising a first flexible perovskite solar cell module sheet configured for deployment directly on a surface of an extant solar cell module. The first flexible perovskite solar cell module sheet has a weight sufficiently low that physical support structures supporting the extant solar cell module support both modules without structural reinforcement. The extant solar cell module comprises one or more of a functional, degraded, failing, or failed solar cell module. A stabilization element secures the first flexible perovskite solar cell module sheet in direct contact with the extant solar cell module surface. The extant solar cell module provides mechanical support for the first flexible perovskite solar cell module sheet. Electrical connections connect the first flexible perovskite solar cell module sheet into solar cell module farm wiring.

### CROSS-REFERENCE TO RELATED APPLICATIONS

This application claims the benefit of U.S. Provisional Application No. 63/777,788, filed Mar. 26, 2025, which is hereby incorporated by reference in its entirety, for all purposes.

### FIELD OF INVENTION

The present disclosure relates to solar energy systems and photovoltaic module deployment, and more particularly to an assembly and method for repowering a solar cell module farm by deploying flexible perovskite solar cell module sheets directly on extant solar cell modules.

### BACKGROUND

Solar photovoltaic technology has undergone substantial development over the past several decades, with crystalline silicon modules dominating utility-scale and commercial installations worldwide. The global installed capacity of solar photovoltaic systems has grown exponentially, with large-scale solar cell module farms representing a considerable portion of renewable energy infrastructure. These installations typically comprise arrays of rigid silicon-based solar cell modules mounted on physical support structures, interconnected through electrical wiring systems, and connected to power conditioning equipment including inverters for grid integration.

The operational lifespan of conventional silicon solar cell modules generally ranges from twenty to thirty years, during which time modules experience gradual performance degradation. This degradation manifests through various mechanisms including potential-induced degradation, light-induced degradation, encapsulant discoloration, cell cracking, and connection failures. Studies in photovoltaic reliability engineering have documented annual degradation rates typically ranging from 0.5% to 1.0% for crystalline silicon modules, though accelerated degradation can occur under certain environmental conditions or due to manufacturing defects. As solar cell module farms approach the end of their designed operational periods, operators face decisions regarding continued operation with diminished output, complete decommissioning, or replacement of aging infrastructure.

The environmental implications of solar cell module farm lifecycle management present considerable challenges. Decommissioning and replacing entire solar cell module farms generates substantial waste streams, as conventional silicon modules contain materials including glass, aluminum, silicon, copper, and various polymers that present recycling challenges. The embodied energy and carbon footprint associated with manufacturing replacement modules, transporting them to installation sites, and disposing of or recycling decommissioned modules represents a non-trivial environmental burden. Furthermore, the physical infrastructure of solar cell module farms—including support posts, mounting frames, pivot mechanisms, and electrical distribution systems—represents substantial capital investment and material resources that may retain considerable useful life even when the solar cell modules themselves have degraded.

Perovskite photovoltaic materials have emerged as a promising class of semiconductors for solar energy conversion applications. The perovskite crystal structure, characterized by the general formula ABX₃, can be engineered using various organic and inorganic components to achieve bandgaps suitable for efficient solar energy harvesting. Laboratory efficiencies for perovskite solar cells have increased rapidly, with certified power conversion efficiencies now approaching or exceeding those of conventional silicon technologies. Perovskite materials offer several technical characteristics of interest, including tunable bandgaps that enable spectral optimization, solution-processable fabrication routes that may reduce manufacturing complexity, and the potential for deposition on flexible substrates.

The development of flexible perovskite solar cell architectures has enabled new form factors for photovoltaic devices. Unlike rigid crystalline silicon modules that require substantial structural support, flexible perovskite solar cells can be fabricated on thin polymer substrates, resulting in lightweight structures that can conform to various surfaces. The layer architecture of such devices typically includes transparent conductive oxides, electron transport layers, the perovskite absorber layer, hole transport layers, and metallic electrodes, with various stabilization and encapsulation layers to address durability considerations. Research efforts have addressed stability challenges associated with perovskite materials through compositional engineering, interface passivation strategies, and encapsulation approaches.

Tandem photovoltaic configurations, wherein multiple absorber materials with different bandgaps are stacked to capture different portions of the solar spectrum, represent an approach to exceeding the theoretical efficiency limits of single-junction devices. Perovskite materials, with their tunable bandgaps, can be configured to absorb higher-energy photons while transmitting lower-energy photons to an underlying absorber such as silicon. Such tandem configurations can theoretically achieve higher overall conversion efficiencies than either material alone, as thermalization losses are reduced when photons are absorbed by materials with bandgaps more closely matched to the photon energies.

The integration of new photovoltaic technologies into existing solar energy infrastructure presents both technical and economic considerations. Utility-scale solar cell module farms represent substantial capital investments, and the physical infrastructure—including land preparation, support structures, electrical distribution systems, grid interconnection equipment, and monitoring systems—often retains value and functionality even as the original solar cell modules degrade. Approaches that can leverage existing infrastructure while upgrading photovoltaic performance may offer advantages in terms of capital efficiency, reduced material consumption, and minimized environmental disruption compared to complete replacement scenarios.

From a commercial perspective, the solar energy industry continues to seek approaches that can extend the productive life of existing installations, reduce the levelized cost of energy, and minimize the environmental footprint associated with solar energy generation. The ability to upgrade aging solar cell module farms without complete decommissioning and replacement could provide operators with options for maintaining or improving energy production while preserving infrastructure investments and reducing waste generation.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a solar cell module repowering assembly is provided. The assembly includes a first flexible perovskite solar cell module sheet configured for deployment directly on a surface of an extant solar cell module. The first flexible perovskite solar cell module sheet has a weight sufficiently low that physical support structures supporting the extant solar cell module support both the extant solar cell module and the first flexible perovskite solar cell module sheet without structural reinforcement. The extant solar cell module comprises one or more of a functional, degraded, failing, or failed solar cell module. The assembly includes a stabilization element configured to stabilize the first flexible perovskite solar cell module sheet on the extant solar cell module. The stabilization element secures the first flexible perovskite solar cell module sheet in direct contact with a surface of the extant solar cell module. The extant solar cell module provides mechanical support for the first flexible perovskite solar cell module sheet. Physical support structures supporting the extant solar cell module support both the extant solar cell module and the first flexible perovskite solar cell module sheet without structural modification. The assembly includes electrical connections configured to connect the first flexible perovskite solar cell module sheet into solar cell module farm wiring.

According to other aspects of the present disclosure, the assembly may include one or more of the following features. The first flexible perovskite solar cell module sheet may be produced in a roll format having a bend radius between 5 centimeters and 50 centimeters. The first flexible perovskite solar cell module sheet may be configured to be unrolled flat for deployment directly onto the surface of the extant solar cell module. The first flexible perovskite solar cell module sheet may be precut to fit atop the extant solar cell module. The precut dimensions may match dimensions of the extant solar cell module. The first flexible perovskite solar cell module sheet may be field cut to fit atop the extant solar cell module on site to accommodate one or more of varying panel sizes across the solar cell module farm, irregular panel shapes, and damaged panels. The stabilization element may comprise a silicone sealant adhesive configured to be applied between the first flexible perovskite solar cell module sheet and the extant solar cell module. The silicone sealant adhesive may enable direct contact between the first flexible perovskite solar cell module sheet and the surface of the extant solar cell module. The stabilization element may comprise mechanical attachment comprising one or more of mounting brackets, screws with washers, and framing brackets. The mechanical attachment may be configured to adjust existing mounting brackets to hold both the extant solar cell module and the first flexible perovskite solar cell module sheet. The electrical connections may be configured to occupy an electrical position in the solar cell module farm wiring. The electrical position may be a position previously occupied by the extant solar cell module prior to disconnection of the extant solar cell module from the solar cell module farm wiring. The electrical connections may comprise connectors compatible with existing farm wiring connectors comprising one or more of MC4, MC3, T4, and H4 connectors. The assembly may further comprise a second flexible perovskite solar cell module sheet configured for deployment over an additional extant solar cell module. The first flexible perovskite solar cell module sheet and the second flexible perovskite solar cell module sheet may define distinct solar energy collection regions when deployed. The first flexible perovskite solar cell module sheet and the second flexible perovskite solar cell module sheet may be configured for progressive deployment across the solar cell module farm. The distinct solar energy collection regions may be configured to form a contiguous solar energy collection region across the extant solar cell module and the additional extant solar cell module. The extant solar cell module and the additional extant solar cell module may be adjacent extant solar cell modules forming a continuous solar energy collection surface. The second flexible perovskite solar cell module sheet may be configured for serial connection with the first flexible perovskite solar cell module sheet. The serial connection may increase voltage output of the combined first and second flexible perovskite solar cell module sheets to form a string. The second flexible perovskite solar cell module sheet may be configured for parallel connection with the first flexible perovskite solar cell module sheet. The parallel connection may increase current output while maintaining voltage at an individual sheet level. The assembly may further comprise an external power conditioning device configured to be positioned between the first flexible perovskite solar cell module sheet and the solar cell module farm wiring. The first flexible perovskite solar cell module sheet may be configured to provide a voltage and current output. The external power conditioning device may be configured to perform one or more of voltage step-up, voltage step-down, and current limiting. The external power conditioning device may be configurable to match one of a plurality of predefined electrical profiles corresponding to different inverter types.

According to another aspect of the present disclosure, a method for repowering a solar cell module is provided. The method comprises deploying a first flexible perovskite solar cell module sheet over an extant solar cell module in a solar cell module farm. The first flexible perovskite solar cell module sheet has a weight sufficiently low that physical support structures supporting the extant solar cell module support both the extant solar cell module and the first flexible perovskite solar cell module sheet without structural reinforcement. The extant solar cell module comprises one or more of a functional, degraded, failing, or failed solar cell module. The first flexible perovskite solar cell module sheet is deployed directly on a surface of the extant solar cell module. The solar cell module farm continues to provide electrical energy from non-repowered extant solar cell modules during the deploying. The method comprises stabilizing the first flexible perovskite solar cell module sheet on the extant solar cell module using a stabilization element. The stabilization element secures the first flexible perovskite solar cell module sheet in direct contact with a surface of the extant solar cell module. The extant solar cell module provides mechanical support for the first flexible perovskite solar cell module sheet. Physical support structures supporting the extant solar cell module continue to support both the extant solar cell module and the first flexible perovskite solar cell module sheet without structural modification. The method comprises connecting electrically the first flexible perovskite solar cell module sheet into solar cell module farm wiring. The method comprises providing electrical energy using the first flexible perovskite solar cell module sheet and the solar cell module farm wiring.

According to other aspects of the present disclosure, the method may include one or more of the following features. The first flexible perovskite solar cell module sheet may be produced in a roll format having a bend radius between 5 centimeters and 50 centimeters enabling transport in a rolled configuration. The first flexible perovskite solar cell module sheet may be one of precut or field cut to fit atop the extant solar cell module. The first flexible perovskite solar cell module sheet may be transported in compact rolls and unrolled directly onto the surface of the extant solar cell module. The stabilizing may comprise one or more of applying a silicone sealant adhesive between the first flexible perovskite solar cell module sheet and the extant solar cell module, mechanically attaching the first flexible perovskite solar cell module sheet to the extant solar cell module using one or more of mounting brackets, screws with washers, and framing brackets, and removable attachment comprising Velcro strips. The stabilizing may enable direct contact between the first flexible perovskite solar cell module sheet and the surface of the extant solar cell module. The method may further comprise disconnecting the extant solar cell module from the solar cell module farm wiring. The extant solar cell module may be electrically deactivated and no longer provides electrical energy. The extant solar cell module may remain in place as a structural mount for the first flexible perovskite solar cell module sheet. The first flexible perovskite solar cell module sheet may occupy an electrical position in the solar cell module farm wiring previously occupied by the extant solar cell module. The disconnecting may comprise one or more of disconnecting output wiring at a junction box of the extant solar cell module and disconnecting connectors of the extant solar cell module from string wiring. The disconnected connectors may be capped. The method may further comprise deploying a second flexible perovskite solar cell module sheet over an additional extant solar cell module. The method may further comprise stabilizing the second flexible perovskite solar cell module sheet on the additional extant solar cell module. The stabilizing may enable distinct solar energy collection regions between the first flexible perovskite solar cell module sheet and the second flexible perovskite solar cell module sheet. The method may further comprise interconnecting the second flexible perovskite solar cell module sheet into the solar cell module farm wiring. The deploying of the second flexible perovskite solar cell module sheet may be part of a progressive deployment across the solar cell module farm. The solar cell module farm may continue to produce electrical energy from non-repowered extant solar cell modules during the progressive deployment. The interconnecting may comprise one of a serial connection, a parallel connection, or a mixed series-parallel configuration between the first flexible perovskite solar cell module sheet and the second flexible perovskite solar cell module sheet. The serial connection may increase voltage and the parallel connection may increase current. The connecting electrically may comprise conditioning an electrical output of the first flexible perovskite solar cell module sheet to match an operating envelope of an existing inverter within the solar cell module farm wiring. The conditioning may comprise one or more of voltage step-up, voltage step-down, current limiting, and output stabilization. The conditioning may be performed by an external power conditioning device positioned between the first flexible perovskite solar cell module sheet and the solar cell module farm wiring. The connecting electrically may comprise reusing one or more existing inverters within the solar cell module farm wiring. The first flexible perovskite solar cell module sheet may be configured to match voltage and current specifications of the extant solar cell module, enabling the one or more existing inverters to continue operating within designed input windows. The first flexible perovskite solar cell module sheet may comprise internal cell wiring in one or more of a series configuration and a parallel configuration to match the voltage and current specifications.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a flowchart for a method for repowering a solar cell module farm, according to aspects of the present disclosure.

FIG. 2 illustrates a flowchart for a method for deploying a second solar module sheet, according to aspects of the present disclosure.

FIG. 3 illustrates a solar power system showing a farm layout with solar cell modules, support structures, electrical connections, and inverters, according to aspects of the present disclosure.

FIG. 4 illustrates a flexible sheet deployment assembly showing a flexible perovskite solar cell module sheet being deployed over an extant solar cell module, according to aspects of the present disclosure.

FIG. 5 illustrates a solar cell system with an existing solar cell module, perovskite cells, wiring, and an inverter/controller, according to aspects of the present disclosure.

FIG. 6 illustrates a tandem solar cell assembly with a perovskite solar sheet positioned over an extant solar panel, according to aspects of the present disclosure.

FIG. 7 illustrates a cross-sectional view of a perovskite solar cell showing a layer stack-up, according to aspects of the present disclosure.

FIG. 8 illustrates a system for AI-based configuration and control of solar cell module farm repowering, according to aspects of the present disclosure.

FIG. 9 illustrates a deactivated panel assembly showing a flexible perovskite solar cell module sheet deployed on an extant solar cell module with a stabilization element, according to aspects of the present disclosure.

FIG. 10 illustrates a progressive deployment farm layout showing repowered and non-repowered extant solar cell modules, according to aspects of the present disclosure.

FIG. 11 illustrates a multi-sheet wiring topology showing serial and parallel connections between flexible perovskite solar cell module sheets, according to aspects of the present disclosure.

FIG. 12 illustrates a PECI integration schematic showing an external power conditioning device positioned between a flexible perovskite solar cell module sheet and solar cell module farm wiring, according to aspects of the present disclosure.

FIG. 13 illustrates an AI configuration control system for determining repowering parameters for a solar cell module farm, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

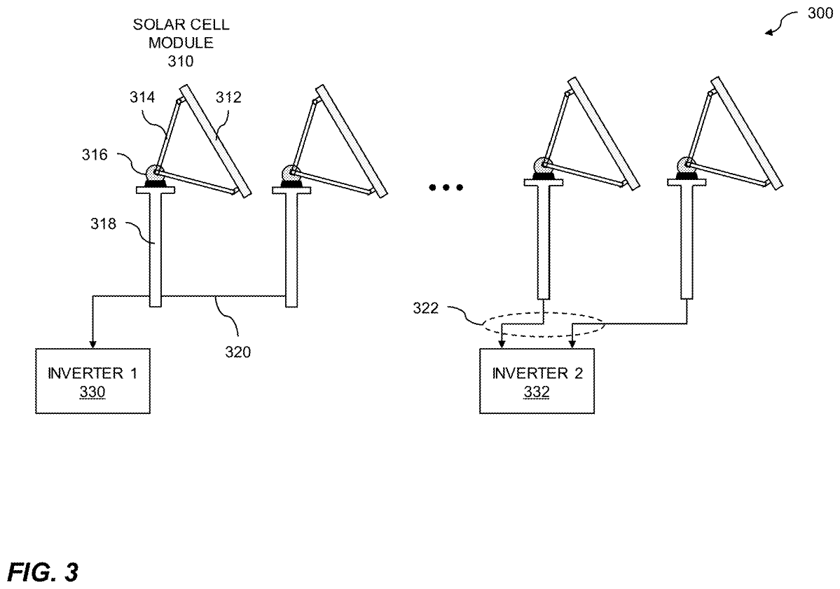

Referring to FIG. 3, a solar power system 300 illustrates an exemplary configuration of a solar cell module farm that may be repowered using the systems and methods described herein. The solar power system 300 comprises a plurality of solar cell modules 310 arranged in a distributed configuration, with each solar cell module 310 including a solar panel 314 mounted on a support frame 312. The support frame 312 may be connected to a support post 318 via a pivot joint 316, which allows for adjustment of the orientation of the solar panel 314 to optimize sun exposure throughout the day or across seasons. The support post 318 provides vertical support and elevation for the solar cell module 310 above ground level, and the pivot joint 316 enables the solar panel 314 and support frame 312 assembly to be tilted or rotated as needed for tracking or seasonal adjustment purposes.

With continued reference to FIG. 3, the solar power system 300 includes electrical infrastructure for collecting and converting the electrical energy generated by the solar cell modules 310. A first group of solar cell modules 310 may be connected to an inverter 1 330 through an electrical connection 320, while a second group of solar cell modules 310 may be connected to an inverter 2 332 through an electrical connection 322. The inverter 1 330 and inverter 2 332 convert the direct current generated by the solar cell modules 310 into alternating current suitable for grid connection or local use. This distributed inverter configuration allows for independent management of different sections of the solar power system 300, which may facilitate maintenance operations and optimize power output from various portions of the installation. The electrical connections 320 and 322 represent the solar cell module farm wiring infrastructure that interconnects the solar cell modules 310 with the inverters and, ultimately, with external loads or the electrical grid.

The solar cell module repowering system described herein addresses the challenge of extending the useful life of existing solar cell module farms, such as the solar power system 300, by deploying flexible perovskite solar cell module sheets over extant solar cell modules. Over time, the solar cell modules 310 within a solar cell module farm may experience degradation in performance, partial failure of individual cells, or complete failure of the module. Rather than requiring complete removal and replacement of such modules—which involves substantial labor, disposal costs, and potential disruption to farm operations—the repowering system enables deployment of lightweight flexible perovskite solar cell module sheets directly on the surfaces of the extant solar cell modules 310, regardless of whether those modules are functional, degraded, failing, or failed.

A solar cell module repowering assembly may comprise a first flexible perovskite solar cell module sheet configured for deployment directly on a surface of an extant solar cell module, such as one of the solar cell modules 310 shown in FIG. 3. The first flexible perovskite solar cell module sheet has a weight sufficiently low that physical support structures supporting the extant solar cell module support both the extant solar cell module and the first flexible perovskite solar cell module sheet without structural reinforcement. In the context of the solar power system 300, this means that the support frame 312, pivot joint 316, and support post 318 that support each solar cell module 310 may continue to support both the extant solar cell module 310 and the deployed flexible perovskite solar cell module sheet without requiring any structural modification or reinforcement to these existing support structures. The lightweight nature of the flexible perovskite solar cell module sheet enables this direct deployment approach, as the additional weight imposed on the existing support infrastructure falls within the design margins of the original installation.

The extant solar cell module over which the first flexible perovskite solar cell module sheet is deployed may comprise one or more of a functional, degraded, failing, or failed solar cell module. This flexibility in the condition of the underlying extant module represents a substantial advantage of the repowering approach, as it allows farm operators to repower modules proactively before complete failure occurs, or to address modules that have already ceased producing electrical energy. In some cases, a functional but aging solar cell module 310 may be repowered to increase overall farm output by adding the generation capacity of the flexible perovskite solar cell module sheet. In other cases, a degraded solar cell module 310 that has experienced significant efficiency losses over years of operation may be repowered to restore or exceed the original generation capacity of that module position within the farm. In still other cases, a failing or failed solar cell module 310 may be repowered to return that module position to productive use without the expense and complexity of removing and replacing the failed module.

The repowering system enables progressive deployment across a solar cell module farm while the farm continues to produce electrical energy from non-repowered modules. As shown in FIG. 3, the solar power system 300 includes multiple solar cell modules 310 distributed across the installation, and the repowering process may proceed incrementally from one module to the next, or from one section of the farm to another, without requiring the entire farm to be taken offline. During the progressive deployment process, the solar cell modules 310 that have not yet been repowered continue to generate electrical energy through the electrical connections 320 and 322 to the inverter 1 330 and inverter 2 332, respectively. This progressive deployment capability allows farm operators to manage the repowering process according to operational constraints, budget availability, and maintenance schedules, while maintaining continuous energy production from the farm throughout the repowering campaign.

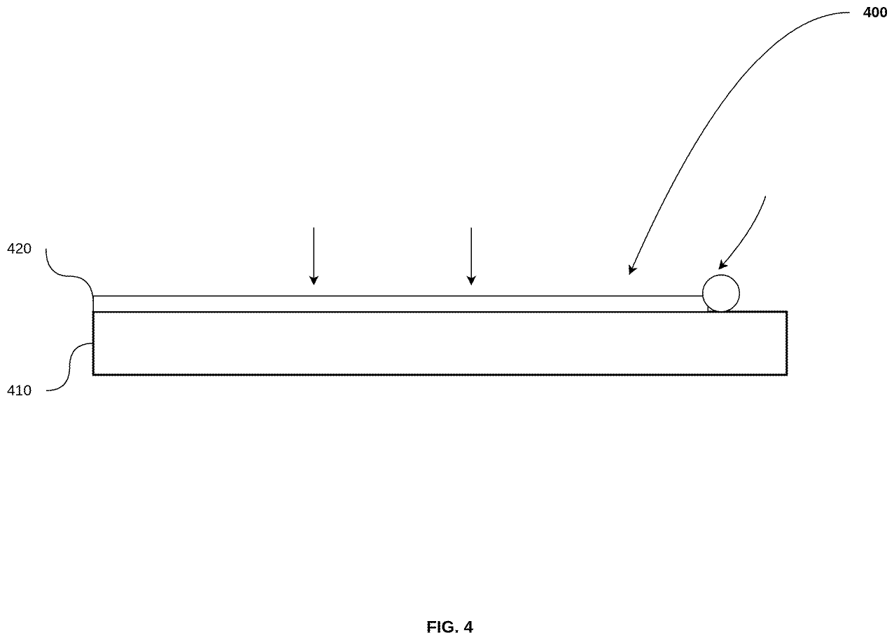

Referring to FIG. 4, a flexible sheet deployment assembly 400 illustrates the deployment configuration in which a flexible perovskite solar cell module sheet 420 is deployed directly onto the surface of an extant solar cell module 410. The flexible sheet deployment assembly 400 demonstrates the direct contact relationship between the flexible perovskite solar cell module sheet 420 and the extant solar cell module 410, wherein the flexible perovskite solar cell module sheet 420 lies flat directly on the upper surface of the extant solar cell module 410 with no gap or spacing between the flexible sheet and the panel surface. The extant solar cell module 410 is depicted as a rectangular cross-section representing a rigid solar panel, and the extant solar cell module 410 serves as a rigid mounting surface that provides mechanical support for the lightweight flexible perovskite solar cell module sheet 420. This direct contact configuration enables the extant solar cell module 410 to provide mechanical support for the flexible perovskite solar cell module sheet 420, with the rigid structure of the extant solar cell module 410 serving as the foundation upon which the flexible sheet rests and operates.

With continued reference to FIG. 4, the flexible perovskite solar cell module sheet 420 may be produced in a roll format having a bend radius between 5 centimeters and 50 centimeters, which enables the flexible perovskite solar cell module sheet 420 to be transported in a compact rolled configuration and subsequently unrolled flat for deployment directly onto the surface of the extant solar cell module 410. The roll portion shown at the right end of the flexible perovskite solar cell module sheet 420 in FIG. 4 indicates that the sheet is being unrolled from a roll format onto the panel surface, with downward arrows above the deployed portion of the flexible perovskite solar cell module sheet 420 indicating the deployment direction. This roll-based deployment approach is analogous to carpet deployment, wherein the flexible perovskite solar cell module sheet 420 is progressively unrolled across the surface of the extant solar cell module 410 until the flexible sheet covers the desired area of the extant module surface. The bend radius range of 5 centimeters to 50 centimeters accommodates various roll diameters suitable for different transportation and handling requirements, with smaller bend radii enabling more compact rolls for easier transport and larger bend radii reducing mechanical stress on the flexible sheet materials during storage and deployment.

The flexible perovskite solar cell module sheet 420 may be configured in different sizing approaches to accommodate the variety of extant solar cell modules that may be present within a solar cell module farm. In some cases, the flexible perovskite solar cell module sheet 420 may be precut to fit atop the extant solar cell module 410, wherein the precut dimensions match dimensions of the extant solar cell module 410. Precut flexible perovskite solar cell module sheets may be manufactured to standard panel dimensions commonly found in solar cell module farms, such as 60-cell, 72-cell, or 96-cell panel formats, enabling rapid deployment without on-site cutting operations. The precut approach may be advantageous when a solar cell module farm comprises uniform panel types and sizes, as the precut sheets may be deployed in a streamlined manner across multiple extant solar cell modules having matching dimensions.

In other cases, the flexible perovskite solar cell module sheet 420 may be field cut to fit atop the extant solar cell module 410 on site to accommodate one or more of varying panel sizes across the solar cell module farm, irregular panel shapes, and damaged panels. Field cutting enables deployment personnel to measure each extant solar cell module 410 and cut the flexible perovskite solar cell module sheet 420 to precise dimensions that match the specific extant module being repowered. This field-cut approach may be particularly advantageous in solar cell module farms that have been expanded over time with different panel generations or manufacturers, resulting in varying panel sizes across the installation. Field cutting may also accommodate irregular panel shapes that may result from custom installations or site-specific constraints, as well as damaged panels that may have broken corners, cracked edges, or other physical damage that affects the available mounting surface area. The flexibility to perform field cutting enables the repowering system to address the heterogeneous conditions commonly encountered in aging solar cell module farms.

As described previously, the flexible perovskite solar cell module sheet 420 has a weight sufficiently low that physical support structures supporting the extant solar cell module 410 support both the extant solar cell module 410 and the flexible perovskite solar cell module sheet 420 without structural modification. In the context of the solar power system 300 shown in FIG. 3, the support frame 312, the pivot joint 316, and the support post 318 that support each solar cell module 310 may continue to support both the extant solar cell module and the deployed flexible perovskite solar cell module sheet without requiring any structural reinforcement or modification to these existing support structures. The lightweight nature of the flexible perovskite solar cell module sheet 420 enables deployment directly onto extant solar cell modules without engineering assessments or structural upgrades to the existing physical support infrastructure, which reduces the cost and complexity of the repowering process.

The flexible sheet deployment assembly 400 may include a stabilization element configured to stabilize the flexible perovskite solar cell module sheet 420 on the extant solar cell module 410. The stabilization element secures the flexible perovskite solar cell module sheet 420 in direct contact with a surface of the extant solar cell module 410, maintaining the direct contact configuration shown in FIG. 4 throughout the operational life of the repowered assembly. The stabilization element may comprise various attachment mechanisms, including adhesive materials, mechanical fasteners, or combinations thereof, as described in further detail below. The stabilization element ensures that the flexible perovskite solar cell module sheet 420 remains securely positioned on the extant solar cell module 410 despite environmental conditions such as wind loading, thermal expansion and contraction, precipitation, and other factors that may otherwise cause displacement or separation of the flexible sheet from the extant module surface.

The flexible sheet deployment assembly 400 may further include electrical connections configured to connect the flexible perovskite solar cell module sheet 420 into solar cell module farm wiring. The electrical connections enable the flexible perovskite solar cell module sheet 420 to provide electrical energy through the existing farm wiring infrastructure, such as the electrical connection 320 and the electrical connection 322 shown in FIG. 3 that connect to the inverter 1 330 and the inverter 2 332, respectively. The electrical connections may be configured to occupy an electrical position in the solar cell module farm wiring that was previously occupied by the extant solar cell module 410 prior to disconnection of the extant solar cell module 410 from the solar cell module farm wiring, enabling the flexible perovskite solar cell module sheet 420 to replace the electrical generation function of the extant module within the existing farm electrical architecture.

The stabilization element configured to stabilize the flexible perovskite solar cell module sheet on the extant solar cell module may comprise various attachment mechanisms that secure the flexible sheet in direct contact with the surface of the extant solar cell module while accommodating different installation requirements, environmental conditions, and operational preferences. The selection of a particular stabilization element or combination of stabilization elements may depend on factors such as the surface characteristics of the extant solar cell module, the expected environmental conditions at the installation site, the desired permanence of the attachment, and the preferences of the installation personnel. Each stabilization approach maintains the direct contact configuration between the flexible perovskite solar cell module sheet and the extant solar cell module surface, ensuring that the extant solar cell module provides mechanical support for the flexible sheet throughout the operational life of the repowered assembly.

In some cases, the stabilization element may comprise a silicone sealant adhesive configured to be applied between the flexible perovskite solar cell module sheet and the extant solar cell module. The silicone sealant adhesive enables direct contact between the flexible perovskite solar cell module sheet and the surface of the extant solar cell module by filling microscopic gaps and irregularities between the flexible sheet and the panel surface while maintaining intimate contact between the two surfaces. Silicone sealant adhesives exhibit properties that make them well-suited for solar cell module applications, including resistance to ultraviolet radiation degradation, tolerance of wide temperature ranges encountered in outdoor solar installations, flexibility that accommodates thermal expansion and contraction cycles, and resistance to moisture penetration. The silicone sealant adhesive may be applied in a continuous layer across the interface between the flexible perovskite solar cell module sheet and the extant solar cell module, or the silicone sealant adhesive may be applied in a pattern such as perimeter beads, grid patterns, or spot applications that provide sufficient adhesion while allowing for potential future removal if needed. The silicone sealant adhesive bonds the flexible perovskite solar cell module sheet to the glass or polymer surface of the extant solar cell module, creating a durable attachment that withstands wind loading, precipitation, and other environmental stresses encountered in solar cell module farm installations.

In other cases, the stabilization element may comprise mechanical attachment comprising one or more of mounting brackets, screws with washers, and framing brackets. Mechanical attachment approaches provide positive retention of the flexible perovskite solar cell module sheet on the extant solar cell module through physical fastening rather than adhesive bonding, which may be preferred in installations where future removal or replacement of the flexible sheet is anticipated, or where adhesive bonding is not suitable due to surface conditions of the extant solar cell module. Mounting brackets may be positioned along the edges or corners of the flexible perovskite solar cell module sheet to clamp the flexible sheet against the surface of the extant solar cell module, with the mounting brackets applying pressure that holds the flexible sheet in direct contact with the extant module surface. Screws with washers may be used to secure mounting brackets or to directly fasten edge portions of the flexible perovskite solar cell module sheet to the frame structure of the extant solar cell module, with the washers distributing fastening loads to prevent damage to the flexible sheet material. Framing brackets may be configured to engage the existing frame of the extant solar cell module and extend over the edges of the flexible perovskite solar cell module sheet, capturing the flexible sheet between the framing bracket and the extant module surface.

The mechanical attachment may be configured to adjust existing mounting brackets to hold both the extant solar cell module and the flexible perovskite solar cell module sheet. Solar cell modules within a solar cell module farm are typically secured to support frames using mounting brackets, clamps, or similar fastening hardware, and these existing mounting brackets may be repositioned, extended, or supplemented to accommodate the additional thickness of the flexible perovskite solar cell module sheet deployed on the extant module surface. In some cases, existing mounting brackets may be loosened, raised slightly to accommodate the flexible sheet thickness, and re-tightened to clamp both the extant solar cell module and the flexible perovskite solar cell module sheet together. In other cases, extension pieces or adapter brackets may be added to existing mounting brackets to increase the clamping range and enable the existing brackets to hold both the extant module and the flexible sheet. This approach of adjusting existing mounting brackets leverages the existing mounting hardware infrastructure of the solar cell module farm, reducing the need for additional fastening components and maintaining compatibility with the original installation configuration. The adjustment of existing mounting brackets does not require structural modification to the physical support structures supporting the extant solar cell module, as the existing brackets are simply repositioned or extended rather than replaced or reinforced.

In still other cases, the stabilization element may comprise removable attachment mechanisms that enable the flexible perovskite solar cell module sheet to be removed and repositioned if needed. Removable attachment may comprise Velcro strips applied between the flexible perovskite solar cell module sheet and the extant solar cell module, with hook-and-loop fastener strips providing secure attachment that can be separated and reattached multiple times without degradation of the attachment capability. Velcro strips may be applied in patterns along the edges of the flexible sheet, in grid patterns across the sheet surface, or in other configurations that provide sufficient attachment strength while enabling removal when desired. When Velcro strips are used as the stabilization element, the Velcro strips may be applied in patterns that leave substantial portions of the flexible sheet surface in direct contact with the extant module surface, with the Velcro strips positioned along edges or at discrete attachment points rather than across the entire interface between the flexible sheet and the extant module. In such configurations, the term “direct contact” encompasses configurations where the flexible perovskite solar cell module sheet is secured against the extant solar cell module surface without an intervening air gap or structural spacer across the primary interface area, and thin attachment materials such as Velcro strips applied at discrete locations do not negate the direct contact relationship between the flexible sheet and the extant module surface across the remainder of the interface. Removable attachment approaches may be advantageous in situations where the flexible perovskite solar cell module sheet may need to be removed for inspection, maintenance, or replacement of either the flexible sheet or the underlying extant solar cell module. The removable attachment maintains direct contact between the flexible perovskite solar cell module sheet and the surface of the extant solar cell module during normal operation while providing the flexibility to separate the components when operational requirements dictate.

Combinations of stabilization elements may be employed to address specific installation requirements or to provide redundant attachment mechanisms. For example, a silicone sealant adhesive may be applied across the central region of the flexible perovskite solar cell module sheet to provide primary adhesion, while mechanical attachment using framing brackets may be employed along the perimeter edges to provide additional security against wind uplift forces. Similarly, Velcro strips may be combined with perimeter mounting brackets to enable removable attachment in the central region while providing positive mechanical retention at the edges. The selection and combination of stabilization elements may be determined based on site-specific factors including wind loading requirements, temperature ranges, accessibility for maintenance, and the expected operational life of the repowered assembly.

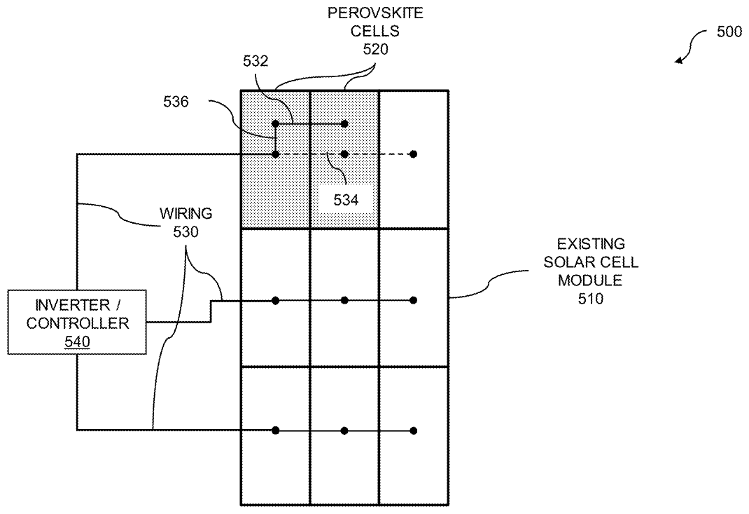

Referring to FIG. 5, a solar cell system 500 illustrates an alternative integration configuration in which perovskite cells 520 are positioned over a portion of an existing solar cell module 510 rather than covering the entire surface of the extant module. The solar cell system 500 demonstrates a partial coverage approach wherein the perovskite cells 520 are overlaid on approximately the upper third of the existing solar cell module 510 in the illustrated embodiment, with the remaining portion of the existing solar cell module 510 remaining uncovered and exposed to incident solar radiation. This partial coverage configuration may be employed in various operational scenarios, such as when selective repowering of specific cell regions is desired, when the perovskite cells 520 are configured to capture particular wavelength ranges while allowing other wavelengths to reach the underlying existing solar cell module 510, or when phased deployment across individual modules is being performed. The existing solar cell module 510 is shown as a rectangular panel divided into multiple cell regions, with the perovskite cells 520 depicted as a shaded area covering the upper portion of the existing solar cell module 510.

With continued reference to FIG. 5, the solar cell system 500 includes a wiring 530 that connects various components together to enable collection and routing of electrical energy generated by both the perovskite cells 520 and the existing solar cell module 510. The wiring 530 provides the electrical interconnection infrastructure that enables the combined output of the perovskite cells 520 and the existing solar cell module 510 to be collected and delivered to downstream power conversion equipment. Multiple connection points 532 are distributed across the existing solar cell module 510, appearing as discrete locations on the panel surface where electrical connections are made. The connection points 532 facilitate electrical connections between the perovskite cells 520 and the existing solar cell module 510, enabling the electrical outputs of both solar energy collection elements to be combined and routed through the wiring 530. The distribution of the connection points 532 across the surface of the existing solar cell module 510 enables flexible wiring configurations that may accommodate various cell arrangements, series and parallel connection topologies, and integration requirements specific to the particular installation.

A cell region 534 is identified in the upper portion of the existing solar cell module 510 where the perovskite cells 520 are overlaid. The cell region 534 represents the area of the existing solar cell module 510 that is covered by the perovskite cells 520, and the cell region 534 may correspond to one or more individual cells or cell groups within the existing solar cell module 510. In the illustrated embodiment, the cell region 534 encompasses the portion of the existing solar cell module 510 beneath the perovskite cells 520, and the connection points 532 within the cell region 534 enable electrical connection to the perovskite cells 520 deployed in that region. A connection line 536 is shown connecting adjacent connection points 532 in the upper portion of the solar cell system 500 where the perovskite cells 520 are located, illustrating the electrical interconnection between adjacent connection points 532 within the cell region 534. The connection line 536 may represent series connections between adjacent perovskite cells within the perovskite cells 520, or the connection line 536 may represent interconnections that enable the perovskite cells 520 to be electrically integrated with the underlying cell region 534 of the existing solar cell module 510.

The wiring 530 extends from the connection points 532 on the existing solar cell module 510 to an inverter/controller 540 positioned adjacent to the module. The inverter/controller 540 receives electrical output from both the perovskite cells 520 and the existing solar cell module 510 through the wiring 530, enabling the inverter/controller 540 to manage the combined electrical output from the tandem configuration of perovskite cells 520 and the existing solar cell module 510. The inverter/controller 540 may perform power conversion functions to convert the direct current generated by the perovskite cells 520 and the existing solar cell module 510 into alternating current suitable for grid connection or local use, similar to the functions performed by the inverter 1 330 and the inverter 2 332 in the solar power system 300 shown in FIG. 3. The inverter/controller 540 may also perform control functions such as maximum power point tracking for each of the perovskite cells 520 and the existing solar cell module 510, load balancing between the two solar energy collection elements, monitoring of individual and combined power output, and fault detection and protection functions.

The configuration of the solar cell system 500 enables the perovskite cells 520 and the existing solar cell module 510 to operate in a combined arrangement wherein both elements contribute to the total electrical energy output of the solar cell system 500. In some cases, the perovskite cells 520 may be configured to absorb certain wavelengths of incident solar radiation while allowing other wavelengths to pass through to the underlying cell region 534 of the existing solar cell module 510, enabling a tandem operation mode in which both the perovskite cells 520 and the existing solar cell module 510 generate electrical energy from different portions of the solar spectrum. In other cases, the perovskite cells 520 may be configured as an opaque overlay that replaces the electrical generation function of the underlying cell region 534, with the existing solar cell module 510 continuing to generate electrical energy from the uncovered portions of the module surface while the perovskite cells 520 generate electrical energy from the covered cell region 534. The inverter/controller 540 manages the electrical output from both the perovskite cells 520 and the existing solar cell module 510, combining the outputs through the wiring 530 and the connection points 532 to provide a unified electrical output from the solar cell system 500.

The partial coverage configuration illustrated in the solar cell system 500 may be employed in conjunction with the full coverage deployment approach illustrated in the flexible sheet deployment assembly 400 shown in FIG. 4, depending on the specific requirements of the repowering application. The solar cell system 500 demonstrates that the perovskite integration approach is not limited to full panel coverage, and that selective deployment of perovskite cells 520 over specific cell regions 534 of an existing solar cell module 510 may be performed to address localized degradation, to implement tandem spectral splitting configurations, or to accommodate other operational requirements. The wiring 530, the connection points 532, and the connection line 536 provide the electrical infrastructure that enables flexible integration of the perovskite cells 520 with the existing solar cell module 510, and the inverter/controller 540 provides the power conversion and control functions that enable the combined output of the solar cell system 500 to be delivered to external loads or the electrical grid.

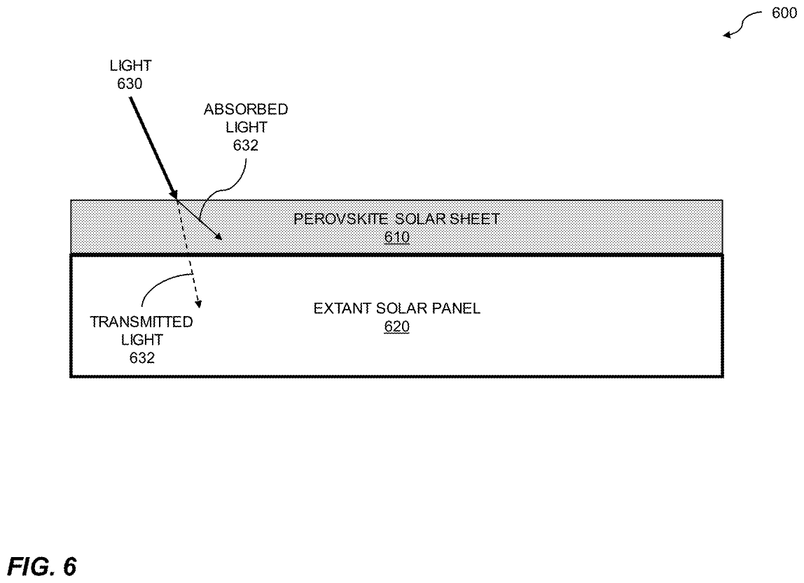

Referring to FIG. 6, a tandem solar cell assembly 600 illustrates a wavelength-selective configuration in which a perovskite solar sheet 610 is positioned above an extant solar panel 620 to enable both solar energy collection elements to generate electrical power from different portions of the incident solar spectrum. The tandem solar cell assembly 600 demonstrates the optical and electrical relationship between the perovskite solar sheet 610 and the extant solar panel 620, wherein the perovskite solar sheet 610 serves as the upper layer that first receives incoming solar radiation, and the extant solar panel 620 serves as the lower layer that receives solar radiation that passes through the perovskite solar sheet 610. This tandem arrangement enables the tandem solar cell assembly 600 to capture a broader range of the solar spectrum than either the perovskite solar sheet 610 or the extant solar panel 620 could capture individually, as each layer is configured to absorb and convert different wavelength ranges of the incident solar radiation into electrical energy.

With continued reference to FIG. 6, light 630 enters the tandem solar cell assembly 600 from above and strikes the perovskite solar sheet 610 as the first optical interface encountered by the incoming solar radiation. The perovskite solar sheet 610 absorbs a portion of the light 630, converting the absorbed photons into electrical energy through the photovoltaic effect within the perovskite material structure. The wavelengths of light 630 that are absorbed by the perovskite solar sheet 610 correspond to the bandgap characteristics of the perovskite material, which may be tuned during manufacturing to target specific portions of the solar spectrum. Perovskite materials exhibit tunable bandgap properties that enable the perovskite solar sheet 610 to be configured to absorb higher-energy photons corresponding to shorter wavelengths of the visible and near-ultraviolet spectrum, while allowing lower-energy photons corresponding to longer wavelengths to pass through the perovskite solar sheet 610 without absorption.

The remaining portion of the light 630 that is not absorbed by the perovskite solar sheet 610 passes through the perovskite solar sheet 610 as transmitted light 632, which then reaches the extant solar panel 620 positioned below the perovskite solar sheet 610. The transmitted light 632 comprises the wavelengths of the incident light 630 that were not absorbed by the perovskite solar sheet 610, and these transmitted wavelengths are available for absorption and conversion by the extant solar panel 620. The extant solar panel 620 may comprise a conventional silicon-based solar panel or other photovoltaic technology that exhibits absorption characteristics complementary to those of the perovskite solar sheet 610, enabling the extant solar panel 620 to efficiently convert the transmitted light 632 into electrical energy. Silicon-based solar panels typically exhibit strong absorption in the near-infrared and red portions of the solar spectrum, which corresponds to the wavelength ranges that may pass through the perovskite solar sheet 610 as transmitted light 632 when the perovskite material is configured to absorb shorter wavelengths.

The wavelength-selective nature of the tandem solar cell assembly 600 enables spectral splitting of the incident light 630 between the perovskite solar sheet 610 and the extant solar panel 620, with each layer converting a different portion of the solar spectrum into electrical energy. The perovskite solar sheet 610 may be configured to absorb wavelengths in the blue, green, and yellow portions of the visible spectrum, corresponding to photon energies above the bandgap of the perovskite material, while the transmitted light 632 comprising red and near-infrared wavelengths passes through to the extant solar panel 620 for conversion by the silicon or other photovoltaic material of the extant panel. This spectral splitting approach reduces thermalization losses that occur when high-energy photons are absorbed by a lower-bandgap material, as the higher-energy photons are instead absorbed by the higher-bandgap perovskite solar sheet 610 where the excess energy above the bandgap is smaller. The complementary absorption characteristics of the perovskite solar sheet 610 and the extant solar panel 620 enable the tandem solar cell assembly 600 to convert a larger fraction of the incident solar energy into electrical energy compared to either layer operating alone.

The tandem configuration of the tandem solar cell assembly 600 increases the overall efficiency of the assembly by enabling both the perovskite solar sheet 610 and the extant solar panel 620 to contribute to the total electrical power output. In a conventional single-junction solar cell, photons with energies below the bandgap are not absorbed and do not contribute to electrical generation, while photons with energies above the bandgap lose their excess energy as heat through thermalization. The tandem solar cell assembly 600 addresses both of these loss mechanisms by providing two absorption layers with different bandgap characteristics, enabling a broader range of photon energies to be converted into electrical energy with reduced thermalization losses. The perovskite solar sheet 610 converts higher-energy photons that would otherwise experience significant thermalization losses in the extant solar panel 620, while the extant solar panel 620 converts lower-energy photons in the transmitted light 632 that would not be absorbed by the perovskite solar sheet 610. The combined electrical output of the perovskite solar sheet 610 and the extant solar panel 620 may exceed the output that either layer could produce individually when exposed to the full spectrum of the light 630.

The tandem solar cell assembly 600 may be implemented using the deployment and stabilization approaches described previously with reference to the flexible sheet deployment assembly 400 shown in FIG. 4, wherein the perovskite solar sheet 610 corresponds to the flexible perovskite solar cell module sheet 420 and the extant solar panel 620 corresponds to the extant solar cell module 410. The perovskite solar sheet 610 may be deployed directly on the surface of the extant solar panel 620 using roll-based deployment, with the perovskite solar sheet 610 being unrolled flat onto the surface of the extant solar panel 620 and stabilized using adhesive, mechanical attachment, or other stabilization elements as described previously. The direct contact configuration between the perovskite solar sheet 610 and the extant solar panel 620 positions the perovskite solar sheet 610 in the optical path of the incident light 630, enabling the wavelength-selective absorption and transmission that characterizes the tandem operation of the tandem solar cell assembly 600. The electrical outputs of the perovskite solar sheet 610 and the extant solar panel 620 may be collected and combined through wiring configurations similar to those described with reference to the solar cell system 500 shown in FIG. 5, enabling the combined electrical output of the tandem solar cell assembly 600 to be delivered to inverters within the solar cell module farm wiring infrastructure.

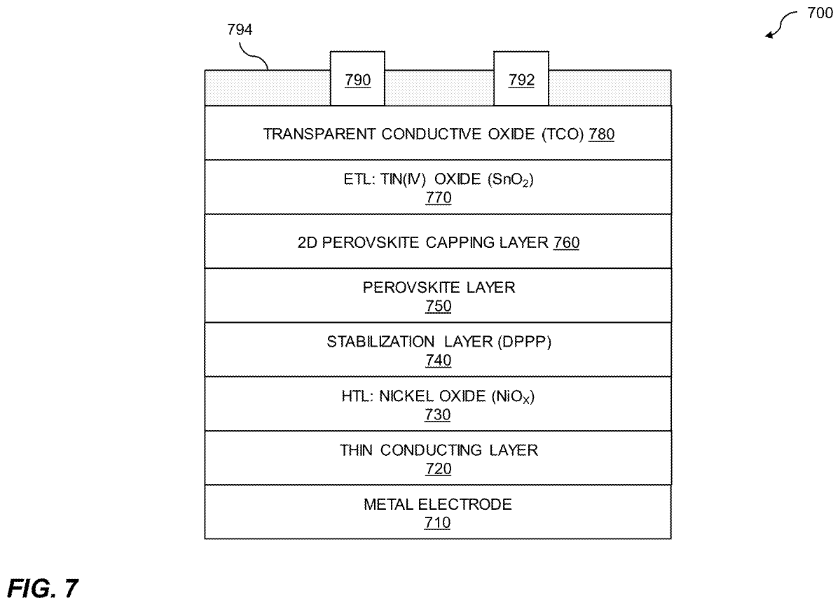

Referring to FIG. 7, a perovskite solar cell 700 illustrates the cross-sectional layer structure of a perovskite photovoltaic device that may be incorporated into the flexible perovskite solar cell module sheet described previously with reference to the flexible sheet deployment assembly 400 shown in FIG. 4 and the perovskite solar sheet 610 of the tandem solar cell assembly 600 shown in FIG. 6. The perovskite solar cell 700 comprises a multi-layer stack of functional materials arranged in a sequence that enables efficient conversion of incident light energy into electrical current, with each layer performing a specific function in the photovoltaic conversion process. The layer structure of the perovskite solar cell 700 is described from the bottom of the structure to the top, corresponding to the sequence in which the layers may be deposited during manufacturing and the direction opposite to the incident light path during operation.

At the bottom of the perovskite solar cell 700 structure is a metal electrode 710, which serves as the base layer of the device and provides one of the two electrical terminals through which photogenerated current is extracted from the perovskite solar cell 700. The metal electrode 710 may comprise various conductive metals suitable for photovoltaic electrode applications, including but not limited to gold, silver, copper, or aluminum, with the selection of the metal electrode 710 material depending on factors such as work function compatibility with adjacent layers, electrical conductivity, chemical stability, and manufacturing considerations. The metal electrode 710 provides a low-resistance current collection path for charge carriers that are transported through the overlying layers of the perovskite solar cell 700, and the metal electrode 710 may be deposited using vacuum deposition techniques such as thermal evaporation or sputtering, or using solution-based deposition techniques such as screen printing of conductive pastes. The metal electrode 710 establishes the electrical foundation of the perovskite solar cell 700 and enables connection of the device to external circuitry for extraction of the photogenerated electrical power.

With continued reference to FIG. 7, a thin conducting layer 720 is positioned above the metal electrode 710 in the layer stack of the perovskite solar cell 700. The thin conducting layer 720 provides semiconductor stability and reduces diffusion of species between the metal electrode 710 and the overlying functional layers of the device. The thin conducting layer 720 may serve as a buffer layer that prevents direct contact between the metal electrode 710 and the charge transport layers, which may otherwise result in undesirable chemical reactions, interdiffusion of metal atoms into the semiconductor layers, or formation of interfacial defects that degrade device performance. The thin conducting layer 720 maintains electrical conductivity to enable charge carrier transport between the metal electrode 710 and the adjacent layers while providing a barrier function that enhances the long-term stability of the perovskite solar cell 700. The thin conducting layer 720 may comprise various materials including thin metal oxide layers, conductive polymer layers, or other materials that exhibit both electrical conductivity and barrier properties suitable for the interfacial position between the metal electrode 710 and the overlying charge transport layer.

A hole transport layer 730 comprising nickel oxide (NiOx) is positioned above the thin conducting layer 720 in the layer structure of the perovskite solar cell 700. The hole transport layer 730 enables current conduction by facilitating the transport of positively charged hole carriers from the active perovskite layer to the metal electrode 710 while blocking the transport of negatively charged electron carriers in the opposite direction. Nickel oxide is a p-type semiconductor material that exhibits favorable energy level alignment with perovskite absorber materials, enabling efficient extraction of holes from the perovskite layer while presenting an energy barrier to electron transport that reduces recombination losses at the interface. The hole transport layer 730 comprising nickel oxide may be deposited using various techniques including sputtering, atomic layer deposition, sol-gel processing, or nanoparticle deposition, with the deposition method affecting the morphology, crystallinity, and electronic properties of the resulting nickel oxide film. The hole transport layer 730 may have a thickness in the range of tens to hundreds of nanometers, with the thickness selected to provide sufficient hole transport capability while maintaining optical transparency to minimize parasitic absorption of light that should reach the perovskite absorber layer.

A stabilization layer 740 comprising DPPP (1,3-bis(diphenylphosphino)propane) is disposed above the hole transport layer 730 in the perovskite solar cell 700 structure. The stabilization layer 740 provides chemical and electronic stabilization at the interface between the hole transport layer 730 and the overlying perovskite layer, enhancing the operational stability and performance of the perovskite solar cell 700. DPPP is an organophosphorus compound that may coordinate with metal ions and passivate defect sites at the interface, reducing non-radiative recombination losses and improving charge extraction efficiency. The stabilization layer 740 comprising DPPP may be applied as a thin interfacial layer using solution-based deposition techniques, with the DPPP molecules forming a self-assembled or partially ordered layer at the interface between the hole transport layer 730 and the perovskite layer. The stabilization layer 740 may improve the adhesion between the hole transport layer 730 and the perovskite layer, reduce interfacial defect density, and enhance the long-term stability of the perovskite solar cell 700 by protecting the interface from degradation mechanisms that may otherwise occur during device operation.

With continued reference to FIG. 7, a perovskite layer 750 is positioned above the stabilization layer 740 and serves as the primary light-absorbing and charge-generating layer of the perovskite solar cell 700. The perovskite layer 750 generates electric current based on light energy impingement, wherein incident photons with energies above the bandgap of the perovskite material are absorbed and generate electron-hole pairs that are subsequently separated and transported to the respective electrodes of the device. The perovskite layer 750 may comprise various perovskite compositions having the general formula ABX₃, where A represents a monovalent cation such as methylammonium, formamidinium, or cesium, B represents a divalent metal cation such as lead or tin, and X represents a halide anion such as iodide, bromide, or chloride. The composition of the perovskite layer 750 may be tuned to achieve desired bandgap characteristics, with mixed-cation and mixed-halide compositions enabling optimization of the absorption spectrum and electronic properties for specific applications. The perovskite layer 750 may have a thickness in the range of hundreds of nanometers to approximately one micrometer, with the thickness selected to provide sufficient light absorption while maintaining efficient charge carrier extraction before recombination occurs.

A 2D perovskite capping layer 760 is disposed above the perovskite layer 750 in the layer structure of the perovskite solar cell 700. The 2D perovskite capping layer 760 enables dangling bond passivation, redox prevention, and smoothed electric potential at the upper surface of the perovskite layer 750. Dangling bond passivation refers to the saturation of unsatisfied chemical bonds at the surface of the perovskite layer 750, which would otherwise act as recombination centers that reduce device efficiency by enabling photogenerated charge carriers to recombine before extraction. The 2D perovskite capping layer 760 comprises a two-dimensional or quasi-two-dimensional perovskite structure that forms at the interface with the underlying three-dimensional perovskite layer 750, with the 2D structure providing a more stable surface termination that resists degradation from moisture, oxygen, and other environmental factors. Redox prevention refers to the protection of the perovskite layer 750 from oxidation and reduction reactions that may degrade the perovskite material during device operation or storage, with the 2D perovskite capping layer 760 serving as a barrier layer that limits exposure of the underlying perovskite layer 750 to reactive species. The smoothed electric potential provided by the 2D perovskite capping layer 760 reduces electric field non-uniformities at the interface that may otherwise cause localized charge accumulation, increased recombination, or accelerated degradation of the perovskite layer 750.

An electron transport layer 770 comprising tin(IV) oxide (SnO₂) is positioned above the 2D perovskite capping layer 760 in the perovskite solar cell 700 structure. The electron transport layer 770 facilitates the transport of negatively charged electron carriers from the perovskite layer 750 to the upper electrode of the device while blocking the transport of positively charged hole carriers in the opposite direction. Tin(IV) oxide is an n-type semiconductor material that exhibits favorable energy level alignment with perovskite absorber materials, enabling efficient extraction of electrons from the perovskite layer 750 while presenting an energy barrier to hole transport that reduces recombination losses at the interface. The electron transport layer 770 comprising tin(IV) oxide may be deposited using various techniques including atomic layer deposition, chemical bath deposition, spin coating of nanoparticle dispersions, or other solution-based and vapor-phase deposition methods. The electron transport layer 770 may have a thickness in the range of tens to hundreds of nanometers, with the thickness selected to provide sufficient electron transport capability while maintaining optical transparency to enable light transmission to the underlying perovskite layer 750.

With continued reference to FIG. 7, a transparent conductive oxide 780 is disposed above the electron transport layer 770 in the layer structure of the perovskite solar cell 700. The transparent conductive oxide 780 enables light transmission through the upper portion of the device while providing electrical conductivity for lateral current collection and transport to the contact electrodes. The transparent conductive oxide 780 may comprise indium tin oxide (ITO), fluorine-doped tin oxide (FTO), aluminum-doped zinc oxide (AZO), or other transparent conductive oxide materials that exhibit both high optical transparency in the visible and near-infrared spectral ranges and high electrical conductivity suitable for current collection in photovoltaic devices. The transparent conductive oxide 780 serves as the upper current-collecting electrode of the perovskite solar cell 700, enabling photogenerated electrons transported through the electron transport layer 770 to be collected and routed to external circuitry. The transparent conductive oxide 780 may be deposited using sputtering, chemical vapor deposition, or other deposition techniques that produce films with the desired combination of optical transparency and electrical conductivity.

A first contact 790 and a second contact 792 are positioned on top of the transparent conductive oxide 780, extending upward from the surface of the perovskite solar cell 700. The first contact 790 and the second contact 792 provide the electrical terminals for photovoltaic operation of the perovskite solar cell 700, enabling connection of the device to external circuitry for extraction of the photogenerated electrical power. The first contact 790 and the second contact 792 may comprise metal contact pads or bus bars that are deposited on the transparent conductive oxide 780 to provide low-resistance connection points for external wiring. The first contact 790 and the second contact 792 may be positioned at opposite edges or corners of the perovskite solar cell 700 to enable current collection from across the active area of the device, with the transparent conductive oxide 780 providing lateral current transport from the active area to the contact locations. The first contact 790 and the second contact 792 may be connected to the wiring 530 and the connection points 532 described previously with reference to the solar cell system 500 shown in FIG. 5, enabling integration of the perovskite solar cell 700 into the solar cell module farm wiring infrastructure.

An anti-reflective coating 794 is disposed on the uppermost surface of the perovskite solar cell 700, covering the area around the first contact 790 and the second contact 792. The anti-reflective coating 794 reduces reflection losses at the air-device interface by providing an optical impedance matching layer that minimizes the fraction of incident light that is reflected away from the perovskite solar cell 700 rather than being transmitted into the device for absorption by the perovskite layer 750. The anti-reflective coating 794 may comprise a single-layer or multi-layer dielectric coating designed to minimize reflection across the wavelength range of interest for the perovskite solar cell 700, with common anti-reflective coating materials including magnesium fluoride, silicon dioxide, silicon nitride, and titanium dioxide. The anti-reflective coating 794 may be deposited using vacuum deposition techniques such as thermal evaporation, electron beam evaporation, or sputtering, with the coating thickness and refractive index selected to provide destructive interference of reflected light waves at the target wavelengths. The anti-reflective coating 794 increases the fraction of incident light 630 that enters the perovskite solar cell 700 for conversion to electrical energy, thereby improving the overall efficiency of the device and the tandem solar cell assembly 600 in which the perovskite solar cell 700 may be incorporated.

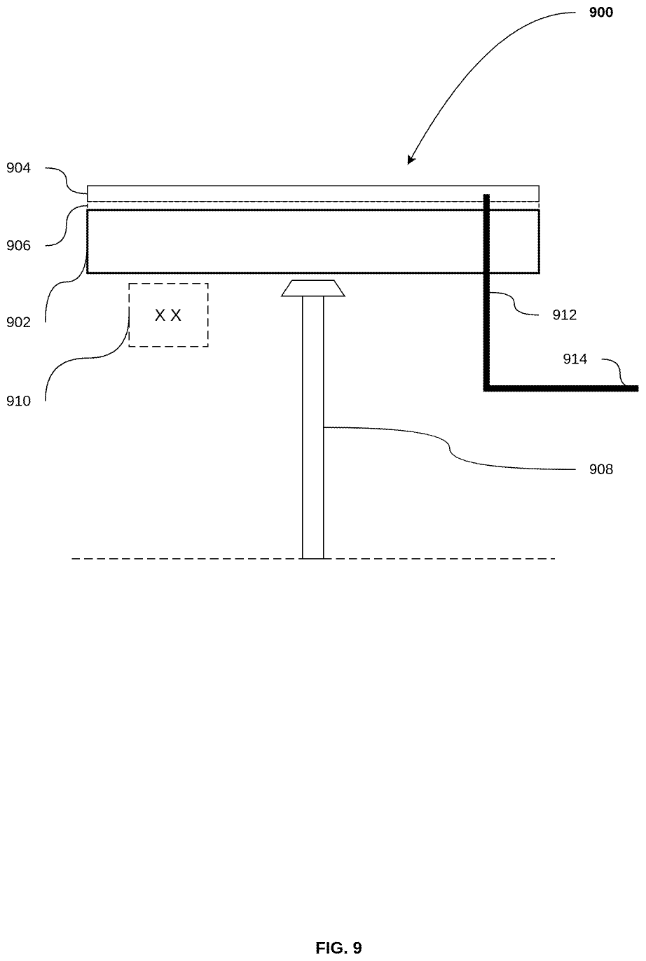

Referring to FIG. 9, a deactivated panel assembly 900 illustrates the primary embodiment of the repowering system in which a flexible perovskite solar cell module sheet 904 is deployed directly on the upper surface of an extant solar cell module 902 that has been electrically deactivated and disconnected from the solar cell module farm wiring. The deactivated panel assembly 900 demonstrates the configuration in which the extant solar cell module 902 serves purely as a rigid mounting surface for the flexible perovskite solar cell module sheet 904, with the extant solar cell module 902 no longer providing electrical energy to the solar cell module farm but remaining physically in place to provide mechanical support for the deployed flexible sheet. This configuration enables the repowering system to leverage the existing physical infrastructure of the solar cell module farm, including the extant solar cell modules and their associated support structures, without requiring removal of the extant modules or modification of the physical support infrastructure.

With continued reference to FIG. 9, the flexible perovskite solar cell module sheet 904 lies flat directly on the upper surface of the extant solar cell module 902, with a stabilization element 906 positioned between the flexible perovskite solar cell module sheet 904 and the extant solar cell module 902. The stabilization element 906 secures the flexible perovskite solar cell module sheet 904 in direct contact with the surface of the extant solar cell module 902, maintaining the direct contact configuration throughout the operational life of the deactivated panel assembly 900. The stabilization element 906 may comprise any of the stabilization mechanisms described previously, including silicone sealant adhesive, mechanical attachment using mounting brackets, screws with washers, or framing brackets, or removable attachment mechanisms such as Velcro strips. The stabilization element 906 ensures that the flexible perovskite solar cell module sheet 904 remains securely positioned on the extant solar cell module 902 despite environmental conditions such as wind loading, thermal expansion and contraction, precipitation, and other factors that may otherwise cause displacement or separation of the flexible sheet from the extant module surface.

The extant solar cell module 902 is electrically deactivated, as indicated by disconnected wiring 910 shown with dashed lines and cap marks in FIG. 9. The disconnected wiring 910 indicates that the extant solar cell module 902 has been electrically disconnected from solar cell module farm wiring 914, with the disconnected wiring 910 representing the former electrical connection between the extant solar cell module 902 and the solar cell module farm wiring 914 that has been severed and capped. The disconnection of the extant solar cell module 902 from the solar cell module farm wiring 914 may be performed by disconnecting output wiring at a junction box of the extant solar cell module 902, by disconnecting connectors of the extant solar cell module 902 from string wiring, or by other disconnection methods appropriate to the particular wiring configuration of the solar cell module farm. The disconnected connectors may be capped to prevent electrical hazards and to protect the disconnected wiring 910 from environmental exposure. Following disconnection, the extant solar cell module 902 no longer provides electrical energy to the solar cell module farm, but the extant solar cell module 902 remains physically in place and serves purely as a rigid mounting surface for the flexible perovskite solar cell module sheet 904.

A sheet wiring connection 912 extends from the flexible perovskite solar cell module sheet 904 and connects to the solar cell module farm wiring 914, replacing the disconnected wiring 910 of the extant solar cell module 902 within the electrical architecture of the solar cell module farm. The sheet wiring connection 912 enables the flexible perovskite solar cell module sheet 904 to provide electrical energy through the existing farm wiring infrastructure, with the electrical output of the flexible perovskite solar cell module sheet 904 being routed through the solar cell module farm wiring 914 to inverters and other power conversion equipment within the farm. The sheet wiring connection 912 may be configured to occupy an electrical position in the solar cell module farm wiring 914 that was previously occupied by the extant solar cell module 902 prior to disconnection of the extant solar cell module 902 from the solar cell module farm wiring 914. This electrical position replacement enables the flexible perovskite solar cell module sheet 904 to assume the electrical role of the extant solar cell module 902 within the existing farm wiring topology, maintaining compatibility with the string configurations, voltage levels, and current ratings of the existing solar cell module farm wiring 914.

The sheet wiring connection 912 may comprise connectors compatible with existing farm wiring connectors comprising one or more of MC4, MC3, T4, and H4 connectors. MC4 connectors are multi-contact connectors commonly used in solar cell module installations, featuring a locking mechanism that provides secure weatherproof connections suitable for outdoor photovoltaic applications. MC3 connectors are an earlier generation of multi-contact connectors that may be present in older solar cell module farms. T4 connectors and H4 connectors are additional connector types that may be encountered in various solar cell module farm installations depending on the manufacturer and installation era of the original equipment. The flexible perovskite solar cell module sheet 904 may include output leads or cables terminating in connector housings compatible with the target connector type used in the solar cell module farm, enabling direct connection to the existing farm wiring without requiring adapter components. In some cases, the flexible perovskite solar cell module sheet 904 may be manufactured with output cables that are factory-terminated with the appropriate connector type matching the existing farm wiring connectors. In other cases, field-installable connectors may be crimped or attached to the output leads of the flexible perovskite solar cell module sheet 904 during deployment, enabling the connector type to be selected on site based on the specific connector types present in the solar cell module farm being repowered. Adapter cables may also be used to interface between the flexible perovskite solar cell module sheet's native output terminals and the existing farm wiring connectors when the native connector type differs from the installed connector type. The compatibility of the sheet wiring connection 912 with these existing farm wiring connectors enables the flexible perovskite solar cell module sheet 904 to be connected directly into the solar cell module farm wiring 914 without requiring modification of the existing wiring infrastructure or replacement of existing connectors. The connector compatibility facilitates rapid deployment of the flexible perovskite solar cell module sheet 904 and integration into the existing electrical architecture of the solar cell module farm.

With continued reference to FIG. 9, a physical support structure 908 supports both the extant solar cell module 902 and the flexible perovskite solar cell module sheet 904 deployed thereon. The physical support structure 908 includes a support post and tilt bracket that provide vertical support, elevation above ground level, and angular positioning for the extant solar cell module 902, similar to the support post 318 and pivot joint 316 described previously with reference to the solar power system 300 shown in FIG. 3. The physical support structure 908 was originally installed to support the extant solar cell module 902, and the physical support structure 908 continues to support both the extant solar cell module 902 and the flexible perovskite solar cell module sheet 904 without requiring any modification to accommodate the deployed flexible sheet. The lightweight nature of the flexible perovskite solar cell module sheet 904 enables the physical support structure 908 to support the combined weight of the extant solar cell module 902 and the flexible perovskite solar cell module sheet 904 within the original design margins of the physical support structure 908, eliminating the need for structural reinforcement or modification that would otherwise increase the cost and complexity of the repowering process.

The deactivated panel assembly 900 demonstrates that the existing physical support infrastructure of a solar cell module farm may be leveraged for repowering without structural modification, with the extant solar cell module 902 serving as a rigid mounting surface for the flexible perovskite solar cell module sheet 904 and the physical support structure 908 continuing to provide mechanical support for the combined assembly. A dashed ground line in FIG. 9 indicates ground level below the physical support structure 908, illustrating the elevated mounting position of the deactivated panel assembly 900 above the ground surface. The elevation provided by the physical support structure 908 positions the flexible perovskite solar cell module sheet 904 at an appropriate height and angle for solar energy collection, with the tilt bracket component of the physical support structure 908 enabling angular positioning that may be optimized for the latitude and seasonal conditions of the installation site. The deactivated panel assembly 900 configuration enables repowering of individual extant solar cell modules within a solar cell module farm while maintaining the physical layout, support infrastructure, and wiring topology of the existing installation.

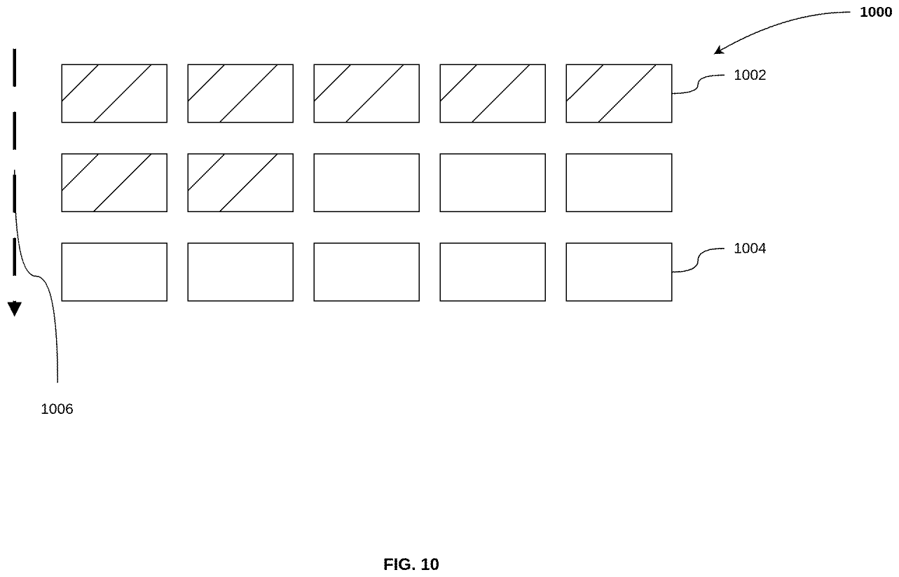

Referring to FIG. 10, a progressive deployment farm layout 1000 illustrates a solar cell module farm during a progressive repowering operation in which flexible perovskite solar cell module sheets are deployed incrementally across the farm while the farm continues to produce electrical energy from modules that have not yet been repowered. The progressive deployment farm layout 1000 demonstrates the spatial and temporal progression of the repowering process across a solar cell module farm, with the farm comprising multiple rows and columns of extant solar cell modules arranged in a grid configuration similar to the arrangement of the solar cell modules 310 in the solar power system 300 described previously with reference to FIG. 3. The progressive deployment farm layout 1000 enables visualization of the repowering status across the farm at a particular point in time during the progressive repowering operation, with different visual representations distinguishing between modules that have been repowered and modules that continue to operate in their original state.

With continued reference to FIG. 10, repowered extant solar cell modules 1002, shown in a shaded pattern in the illustrated embodiment, represent modules over which flexible perovskite solar cell module sheets have been deployed, stabilized, and connected into the solar cell module farm wiring 914. Each repowered extant solar cell module 1002 corresponds to a configuration similar to the deactivated panel assembly 900 described previously with reference to FIG. 9, wherein a flexible perovskite solar cell module sheet 904 has been deployed directly on the surface of an extant solar cell module 902, stabilized using a stabilization element 906, and connected into the solar cell module farm wiring 914 via a sheet wiring connection 912. The repowered extant solar cell modules 1002 occupy the upper-left portion of the progressive deployment farm layout 1000 in the illustrated embodiment, indicating that the repowering operation has progressed from one section of the farm toward the remainder of the installation. The repowered extant solar cell modules 1002 provide electrical energy to the solar cell module farm through the deployed flexible perovskite solar cell module sheets, with the underlying extant solar cell modules serving as rigid mounting surfaces that provide mechanical support for the flexible sheets as described previously.

The progressive deployment farm layout 1000 further includes non-repowered extant solar cell modules 1004, shown in an unshaded pattern in the illustrated embodiment, representing modules that have not yet been repowered and continue to operate in their original state producing solar cell module electrical energy. The non-repowered extant solar cell modules 1004 occupy the lower-right portion of the progressive deployment farm layout 1000 in the illustrated embodiment, representing the section of the farm that has not yet been reached by the progressive repowering operation. Each non-repowered extant solar cell module 1004 continues to generate electrical energy through the original photovoltaic cells of the extant module, with the electrical output being routed through the solar cell module farm wiring 914 to inverters such as the inverter 1 330 and the inverter 2 332 described previously with reference to FIG. 3. The non-repowered extant solar cell modules 1004 may comprise functional modules operating at or near original efficiency, degraded modules that have experienced performance losses over time, or modules in various states of partial degradation, with the progressive repowering operation addressing these modules in sequence as the deployment progresses across the farm.

A deployment sequence direction 1006, indicated by a dashed arrow in FIG. 10, shows the direction in which the progressive deployment proceeds across the progressive deployment farm layout 1000. The deployment sequence direction 1006 illustrates the spatial progression of the repowering operation from the repowered extant solar cell modules 1002 toward the non-repowered extant solar cell modules 1004, with the deployment progressing section-by-section across the farm. The deployment sequence direction 1006 may follow various patterns depending on the operational requirements and constraints of the particular solar cell module farm, including row-by-row progression, column-by-column progression, zone-based progression, or other deployment sequences that accommodate factors such as access routes, wiring configurations, inverter groupings, and maintenance schedules. The deployment sequence direction 1006 enables farm operators to plan and execute the repowering operation in a systematic manner that minimizes disruption to ongoing farm operations while progressively increasing the generation capacity of the repowered sections.

The progressive deployment farm layout 1000 demonstrates that the solar cell module farm never goes offline during the progressive repowering operation, as the non-repowered extant solar cell modules 1004 continue to produce electrical energy while additional modules are being repowered. This continuous operation capability represents a substantial advantage of the progressive deployment approach, as the farm maintains electrical energy production throughout the repowering campaign rather than requiring a complete shutdown that would result in lost generation revenue and potential grid supply disruptions. The pace of deployment across the progressive deployment farm layout 1000 may be adjusted based on operational constraints, including factors such as available installation personnel, budget availability, equipment delivery schedules, weather conditions, and grid demand patterns. Farm operators may accelerate the deployment pace during periods of favorable conditions or reduced grid demand, or may slow the deployment pace during periods when operational constraints limit the available resources for repowering activities.

As described previously with reference to the deactivated panel assembly 900 shown in FIG. 9, the repowering assembly may comprise a first flexible perovskite solar cell module sheet configured for deployment directly on a surface of an extant solar cell module, and the repowering assembly may further comprise a second flexible perovskite solar cell module sheet configured for deployment over an additional extant solar cell module. In the context of the progressive deployment farm layout 1000, the first flexible perovskite solar cell module sheet and the second flexible perovskite solar cell module sheet may be deployed over adjacent repowered extant solar cell modules 1002, with each flexible perovskite solar cell module sheet defining a distinct solar energy collection region when deployed. The first flexible perovskite solar cell module sheet and the second flexible perovskite solar cell module sheet are configured for progressive deployment across the solar cell module farm, as illustrated by the deployment sequence direction 1006 that indicates the progression of the repowering operation from the repowered extant solar cell modules 1002 toward the non-repowered extant solar cell modules 1004.

With continued reference to FIG. 10, the distinct solar energy collection regions defined by the first flexible perovskite solar cell module sheet and the second flexible perovskite solar cell module sheet may be configured to form a contiguous solar energy collection region across the extant solar cell module and the additional extant solar cell module. When the extant solar cell module and the additional extant solar cell module are adjacent extant solar cell modules within the progressive deployment farm layout 1000, the deployment of flexible perovskite solar cell module sheets over both adjacent modules creates a continuous solar energy collection surface that spans across the two underlying extant modules. The contiguous solar energy collection region formed by the adjacent flexible perovskite solar cell module sheets enables coordinated electrical collection from the combined surface area, with the sheet wiring connections from each flexible sheet being integrated into the solar cell module farm wiring 914 to provide combined electrical output from the contiguous collection region. The adjacent repowered extant solar cell modules 1002 shown in the upper-left portion of the progressive deployment farm layout 1000 illustrate this contiguous configuration, wherein multiple adjacent extant solar cell modules have been repowered with flexible perovskite solar cell module sheets that together form a continuous solar energy collection surface across the repowered section of the farm.

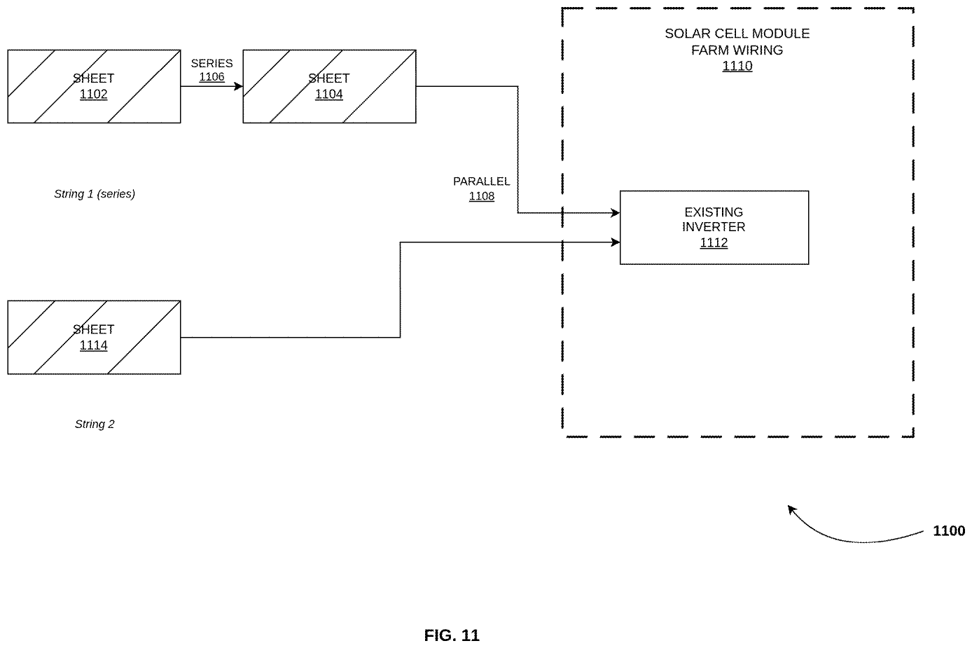

Referring to FIG. 11, a multi-sheet wiring topology 1100 illustrates the electrical interconnection of multiple flexible perovskite solar cell module sheets within a solar cell module farm, demonstrating the various series and parallel connection configurations that may be employed to match the voltage and current specifications of the existing farm wiring infrastructure and inverter operating windows. The multi-sheet wiring topology 1100 provides a schematic representation of how multiple flexible perovskite solar cell module sheets deployed across a solar cell module farm, such as the repowered extant solar cell modules 1002 shown in the progressive deployment farm layout 1000 described previously with reference to FIG. 10, may be electrically interconnected to form strings and parallel groups that integrate with the solar cell module farm wiring 914 and existing inverters within the farm electrical architecture. The multi-sheet wiring topology 1100 demonstrates that the flexible perovskite solar cell module sheets are not directly connected to inverter electrode layers, but rather connect into the existing solar cell module farm wiring which in turn routes electrical energy to the existing inverters as part of the farm's electrical infrastructure.

With continued reference to FIG. 11, a first flexible perovskite solar cell module sheet 1102 is connected in series to a second flexible perovskite solar cell module sheet 1104 via a serial connection 1106, forming a first string within the multi-sheet wiring topology 1100. The serial connection 1106 electrically couples the first flexible perovskite solar cell module sheet 1102 and the second flexible perovskite solar cell module sheet 1104 in a series configuration wherein the positive terminal of one sheet is connected to the negative terminal of the adjacent sheet, resulting in the voltages of the two sheets being additive while the current through the series-connected sheets remains equal to the current produced by each individual sheet. The serial connection 1106 increases voltage output of the combined first flexible perovskite solar cell module sheet 1102 and second flexible perovskite solar cell module sheet 1104 to form a string, with the string voltage being the sum of the individual voltages produced by each of the series-connected flexible perovskite solar cell module sheets. This voltage increase achieved through the serial connection 1106 enables the first string to produce a combined voltage that may match the input voltage requirements of the existing inverters within the solar cell module farm wiring, as the original extant solar cell modules within the farm were typically configured in series strings to achieve the voltage levels expected by the inverter input stages.

The multi-sheet wiring topology 1100 further includes a third flexible perovskite solar cell module sheet 1114 that forms a second string within the electrical architecture of the repowered solar cell module farm. The third flexible perovskite solar cell module sheet 1114 may comprise a single flexible perovskite solar cell module sheet forming a single-sheet string, or the third flexible perovskite solar cell module sheet 1114 may be representative of a string comprising multiple series-connected flexible perovskite solar cell module sheets similar to the first string formed by the first flexible perovskite solar cell module sheet 1102 and the second flexible perovskite solar cell module sheet 1104. The second string formed by the third flexible perovskite solar cell module sheet 1114 operates in parallel with the first string, enabling the multi-sheet wiring topology 1100 to combine the electrical outputs of multiple strings to increase the total current delivered to the solar cell module farm wiring while maintaining the string voltage level established by the series connections within each string.

With continued reference to FIG. 11, the first string comprising the first flexible perovskite solar cell module sheet 1102 and the second flexible perovskite solar cell module sheet 1104 and the second string comprising the third flexible perovskite solar cell module sheet 1114 are connected via a parallel connection 1108 to a solar cell module farm wiring 1110. The parallel connection 1108 electrically couples the first string and the second string in a parallel configuration wherein the positive terminals of both strings are connected together and the negative terminals of both strings are connected together, resulting in the currents from the two strings being additive while the voltage across the parallel-connected strings remains equal to the voltage of each individual string. The parallel connection 1108 increases current output while maintaining voltage at an individual sheet level, enabling the combined output of multiple strings to deliver increased current capacity to the solar cell module farm wiring 1110 without exceeding the voltage specifications of the existing inverters. The parallel connection 1108 configuration enables scaling of the total current output from the repowered section of the solar cell module farm by adding additional strings in parallel, with each additional parallel string contributing its current output to the combined total while the voltage remains at the string voltage level established by the series connections within each string.

The solar cell module farm wiring 1110, shown as a dashed container in FIG. 11, represents the existing electrical infrastructure of the solar cell module farm that interconnects the solar cell modules with the inverters and external loads or grid connections. The solar cell module farm wiring 1110 corresponds to the solar cell module farm wiring 914 described previously with reference to the deactivated panel assembly 900 shown in FIG. 9, and the solar cell module farm wiring 1110 includes the conductors, junction boxes, combiner boxes, and other electrical components that route the electrical energy generated by the solar cell modules to the power conversion equipment within the farm. An existing inverter 1112 is positioned within the solar cell module farm wiring 1110, indicating that the existing inverter 1112 is a component of the farm wiring infrastructure rather than a separate element to which the flexible perovskite solar cell module sheets connect directly. The existing inverter 1112 corresponds to the inverter 1 330 and the inverter 2 332 described previously with reference to the solar power system 300 shown in FIG. 3, and the existing inverter 1112 converts the direct current received from the solar cell module farm wiring 1110 into alternating current suitable for grid connection or local use.

The multi-sheet wiring topology 1100 demonstrates that the first flexible perovskite solar cell module sheet 1102, the second flexible perovskite solar cell module sheet 1104, and the third flexible perovskite solar cell module sheet 1114 connect into the solar cell module farm wiring 1110, and the solar cell module farm wiring 1110 routes electrical energy to the existing inverter 1112. This connection architecture distinguishes the repowering system from configurations in which photovoltaic elements are directly connected to inverter electrode layers, as the flexible perovskite solar cell module sheets interface with the existing farm wiring infrastructure rather than with the internal components of the inverter. The solar cell module farm wiring 1110 serves as the intermediary electrical infrastructure that collects the outputs from the flexible perovskite solar cell module sheets, combines the outputs according to the series and parallel connection topology established by the serial connection 1106 and the parallel connection 1108, and delivers the combined electrical energy to the existing inverter 1112 for power conversion. This architecture enables the repowering system to leverage the existing inverter infrastructure of the solar cell module farm without requiring replacement of the existing inverter 1112, as the flexible perovskite solar cell module sheets may be configured through appropriate series and parallel connections to match the voltage and current specifications expected by the existing inverter 1112 input stage.

As described previously with reference to the repowering assembly, the second flexible perovskite solar cell module sheet 1104 is configured for serial connection with the first flexible perovskite solar cell module sheet 1102, and the serial connection 1106 increases voltage output of the combined first flexible perovskite solar cell module sheet 1102 and second flexible perovskite solar cell module sheet 1104 to form a string. The serial connection 1106 enables the string voltage to be increased to match the input voltage window of the existing inverter 1112, as the original extant solar cell modules within the solar cell module farm were typically configured in series strings that produced voltages within the designed input range of the existing inverter 1112. By configuring the flexible perovskite solar cell module sheets in series connections that replicate the voltage characteristics of the original extant solar cell module strings, the repowering system enables the existing inverter 1112 to continue operating within its designed input windows without requiring reconfiguration or replacement of the inverter.

The second flexible perovskite solar cell module sheet 1104 may alternatively be configured for parallel connection with the first flexible perovskite solar cell module sheet 1102, and the parallel connection 1108 increases current output while maintaining voltage at an individual sheet level. The parallel connection configuration may be employed when the voltage output of individual flexible perovskite solar cell module sheets matches the input voltage requirements of the existing inverter 1112, or when the parallel connection is used to combine the outputs of multiple strings that have each been configured through series connections to achieve the desired string voltage. The flexibility to configure the flexible perovskite solar cell module sheets in series connections, parallel connections, or mixed series-parallel configurations enables the multi-sheet wiring topology 1100 to accommodate various inverter input specifications and farm wiring configurations that may be encountered across different solar cell module farm installations.

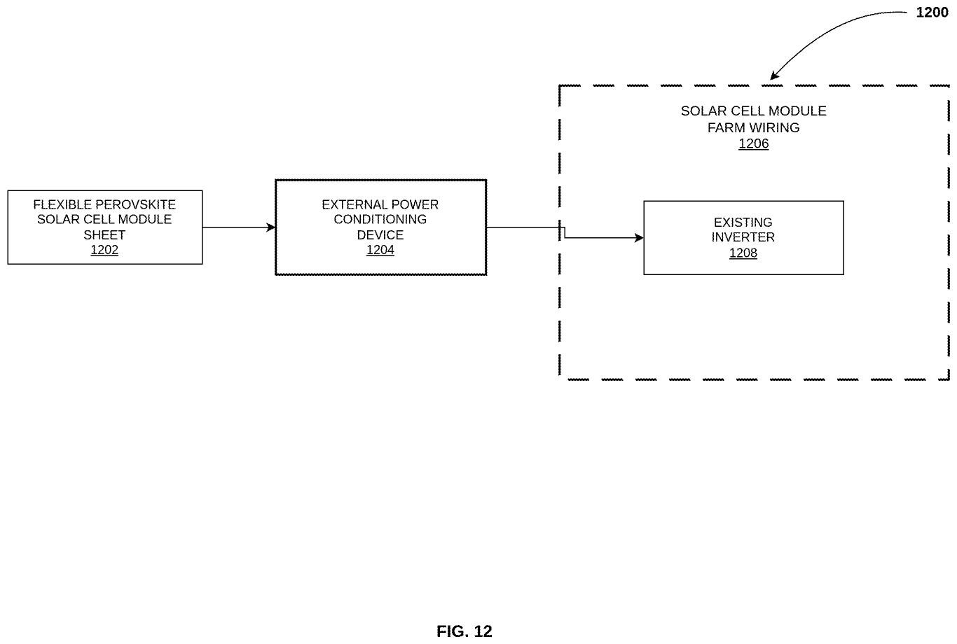

Referring to FIG. 12, a PECI integration schematic 1200 illustrates the integration of an external power conditioning device into the solar cell module farm repowering system, demonstrating an alternative approach to achieving electrical compatibility between the flexible perovskite solar cell module sheets and the existing inverter infrastructure of a solar cell module farm. The PECI integration schematic 1200 provides a schematic representation of the electrical signal path from a flexible perovskite solar cell module sheet 1202 through an external power conditioning device 1204 to a solar cell module farm wiring 1206 and an existing inverter 1208, illustrating how the external power conditioning device 1204 serves as an intermediary component that transforms the electrical output characteristics of the flexible perovskite solar cell module sheet 1202 to match the input requirements of the existing inverter 1208. This integration approach enables the repowering system to accommodate situations in which the native electrical output characteristics of the flexible perovskite solar cell module sheet 1202 do not directly match the operating envelope of the existing inverter 1208, providing an alternative to the series and parallel connection configurations described previously with reference to the multi-sheet wiring topology 1100 shown in FIG. 11.

With continued reference to FIG. 12, the flexible perovskite solar cell module sheet 1202 provides electrical output to the external power conditioning device 1204, with the electrical output comprising a voltage and current output generated by the photovoltaic conversion process within the perovskite solar cells of the flexible perovskite solar cell module sheet 1202. The flexible perovskite solar cell module sheet 1202 corresponds to the flexible perovskite solar cell module sheet 904 described previously with reference to the deactivated panel assembly 900 shown in FIG. 9, and the flexible perovskite solar cell module sheet 1202 may be deployed directly on the surface of an extant solar cell module using the deployment and stabilization approaches described previously. The voltage and current output provided by the flexible perovskite solar cell module sheet 1202 depends on factors including the number of perovskite solar cells within the flexible sheet, the internal wiring configuration of those cells in series and parallel arrangements, the incident solar irradiance level, and the operating temperature of the flexible sheet. The electrical output of the flexible perovskite solar cell module sheet 1202 is delivered to the external power conditioning device 1204 through wiring connections that couple the output terminals of the flexible perovskite solar cell module sheet 1202 to the input terminals of the external power conditioning device 1204.

The external power conditioning device 1204 is positioned between the flexible perovskite solar cell module sheet 1202 and the solar cell module farm wiring 1206, serving as an intermediary power conversion stage that transforms the electrical output of the flexible perovskite solar cell module sheet 1202 before the electrical energy enters the solar cell module farm wiring 1206. The positioning of the external power conditioning device 1204 between the flexible perovskite solar cell module sheet 1202 and the solar cell module farm wiring 1206 enables the external power conditioning device 1204 to receive the native electrical output of the flexible perovskite solar cell module sheet 1202 and to produce a conditioned electrical output that is compatible with the electrical characteristics expected by the solar cell module farm wiring 1206 and the existing inverter 1208. The external power conditioning device 1204 may be physically located in proximity to the flexible perovskite solar cell module sheet 1202, such as mounted on the physical support structure 908 described previously with reference to the deactivated panel assembly 900 shown in FIG. 9, or the external power conditioning device 1204 may be located at a central collection point within the solar cell module farm where multiple flexible perovskite solar cell module sheets feed into a shared power conditioning stage.

The external power conditioning device 1204 transforms the electrical output of the flexible perovskite solar cell module sheet 1202 to match an operating envelope of the existing inverter 1208 within the solar cell module farm wiring 1206. The operating envelope of the existing inverter 1208 comprises the range of input voltage levels, input current levels, and power levels over which the existing inverter 1208 is designed to operate efficiently and safely, with the operating envelope being determined by the design specifications of the existing inverter 1208 as originally installed in the solar cell module farm. The existing inverter 1208 was designed to receive electrical input from the original extant solar cell modules within the solar cell module farm, and the operating envelope of the existing inverter 1208 reflects the voltage and current characteristics of those original extant solar cell modules when configured in the string and parallel arrangements of the original farm wiring topology. The external power conditioning device 1204 transforms the electrical output of the flexible perovskite solar cell module sheet 1202 such that the conditioned output falls within the operating envelope of the existing inverter 1208, enabling the existing inverter 1208 to continue operating within its designed input windows without requiring reconfiguration or replacement.

With continued reference to FIG. 12, the external power conditioning device 1204 is configured to perform one or more of voltage step-up, voltage step-down, and current limiting to achieve the transformation of the electrical output of the flexible perovskite solar cell module sheet 1202 to match the operating envelope of the existing inverter 1208. Voltage step-up, also referred to as boost conversion, increases the voltage level of the electrical output from the flexible perovskite solar cell module sheet 1202 to a higher voltage level that falls within the input voltage range of the existing inverter 1208, which may be employed when the native output voltage of the flexible perovskite solar cell module sheet 1202 is lower than the minimum input voltage threshold of the existing inverter 1208. Voltage step-down, also referred to as buck conversion, decreases the voltage level of the electrical output from the flexible perovskite solar cell module sheet 1202 to a lower voltage level that falls within the input voltage range of the existing inverter 1208, which may be employed when the native output voltage of the flexible perovskite solar cell module sheet 1202 exceeds the maximum input voltage threshold of the existing inverter 1208. Current limiting restricts the current level of the electrical output from the flexible perovskite solar cell module sheet 1202 to a maximum current level that does not exceed the current handling capacity of the existing inverter 1208 input stage, protecting the existing inverter 1208 from overcurrent conditions that may otherwise cause damage or trigger protective shutdown of the inverter.

The external power conditioning device 1204 may perform combinations of voltage step-up, voltage step-down, and current limiting depending on the specific mismatch between the native electrical output characteristics of the flexible perovskite solar cell module sheet 1202 and the operating envelope of the existing inverter 1208. In some cases, the external power conditioning device 1204 may perform voltage step-up to increase the output voltage of the flexible perovskite solar cell module sheet 1202 while simultaneously performing current limiting to ensure that the increased voltage does not result in current levels that exceed the capacity of the existing inverter 1208. In other cases, the external power conditioning device 1204 may perform voltage step-down to reduce the output voltage of the flexible perovskite solar cell module sheet 1202 to a level that falls within the optimal efficiency range of the existing inverter 1208, even when the native output voltage would technically fall within the acceptable input range of the inverter. The external power conditioning device 1204 may incorporate DC-DC converter circuitry, such as buck converters, boost converters, buck-boost converters, or other power conversion topologies, to perform the voltage transformation functions, along with current sensing and limiting circuitry to perform the current limiting function.

The external power conditioning device 1204 is configurable to match one of a plurality of predefined electrical profiles corresponding to different inverter types, enabling the flexible perovskite solar cell module sheet 1202 to be connected into the solar cell module farm wiring 1206 without requiring replacement of the existing inverter 1208 across a wide range of solar cell module farm installations that may employ different inverter manufacturers, models, and specifications. The plurality of predefined electrical profiles may comprise stored configuration parameters that define the target output voltage range, target output current range, maximum power point tracking parameters, and other electrical characteristics that correspond to the operating envelopes of different inverter types commonly encountered in solar cell module farm installations. Each predefined electrical profile may correspond to a specific inverter manufacturer and model, a category of inverters sharing similar input specifications, or a generic profile that accommodates a range of inverter types within a particular voltage and current class. The configurability of the external power conditioning device 1204 enables a single external power conditioning device design to be deployed across multiple solar cell module farm installations having different existing inverter types, with the appropriate predefined electrical profile being selected during installation or commissioning to match the specific existing inverter 1208 present in each installation.

The plurality of predefined electrical profiles stored within the external power conditioning device 1204 may comprise configuration parameters that define the target electrical output characteristics for different inverter types. Each predefined electrical profile may include parameters such as target output voltage range, target output current range, maximum power point tracking voltage windows, current limits, and safety constraints including overvoltage protection thresholds and overcurrent protection thresholds. The predefined electrical profiles may correspond to specific inverter manufacturers and models, such as profiles for particular string inverter product lines from various manufacturers, or the predefined electrical profiles may correspond to categories of inverters sharing similar input specifications, such as a profile for residential string inverters with input voltage ranges of 200V to 400V or a profile for commercial string inverters with input voltage ranges of 300V to 600V. The predefined electrical profiles may be stored in non-volatile memory within the external power conditioning device 1204, enabling the profiles to be retained when the device is powered off and accessed when the device is powered on during operation. Profile selection may be performed through various mechanisms, including physical switches or jumpers on the external power conditioning device 1204 that select among stored profiles, a digital interface such as a serial communication port or wireless interface through which a technician may select or upload profiles, or automatic detection of system characteristics wherein the external power conditioning device 1204 measures the electrical characteristics of the connected solar cell module farm wiring 1206 and automatically selects a matching profile from the stored plurality of predefined electrical profiles.

The solar cell module farm wiring 1206, shown as a dashed container in FIG. 12, represents the existing electrical infrastructure of the solar cell module farm, corresponding to the solar cell module farm wiring 914 described previously with reference to the deactivated panel assembly 900 shown in FIG. 9 and the solar cell module farm wiring 1110 described previously with reference to the multi-sheet wiring topology 1100 shown in FIG. 11. The existing inverter 1208 is positioned within the solar cell module farm wiring 1206, indicating that the existing inverter 1208 is a component of the farm wiring infrastructure that receives electrical energy from the solar cell module farm wiring 1206 and converts the direct current into alternating current suitable for grid connection or local use. The existing inverter 1208 corresponds to the inverter 1 330 and the inverter 2 332 described previously with reference to the solar power system 300 shown in FIG. 3, and the existing inverter 1208 corresponds to the existing inverter 1112 described previously with reference to the multi-sheet wiring topology 1100 shown in FIG. 11. The conditioned electrical output from the external power conditioning device 1204 is delivered to the solar cell module farm wiring 1206, which routes the electrical energy to the existing inverter 1208 for power conversion.

The PECI integration schematic 1200 demonstrates that the external power conditioning device 1204 enables the flexible perovskite solar cell module sheet 1202 to be connected into the existing solar cell module farm wiring 1206 without requiring replacement of the existing inverter 1208, reducing the cost and complexity of the repowering process by leveraging the existing inverter infrastructure of the solar cell module farm. As described previously with reference to the repowering assembly, the repowering assembly may further comprise an external power conditioning device configured to be positioned between the first flexible perovskite solar cell module sheet and the solar cell module farm wiring, wherein the first flexible perovskite solar cell module sheet is configured to provide a voltage and current output, and wherein the external power conditioning device is configured to perform one or more of voltage step-up, voltage step-down, and current limiting, and wherein the external power conditioning device is configurable to match one of a plurality of predefined electrical profiles corresponding to different inverter types. The PECI integration schematic 1200 illustrates this configuration, with the external power conditioning device 1204 providing the voltage and current transformation functions that enable the flexible perovskite solar cell module sheet 1202 to interface with the existing inverter 1208 through the solar cell module farm wiring 1206 regardless of whether the native electrical output characteristics of the flexible perovskite solar cell module sheet 1202 directly match the operating envelope of the existing inverter 1208.

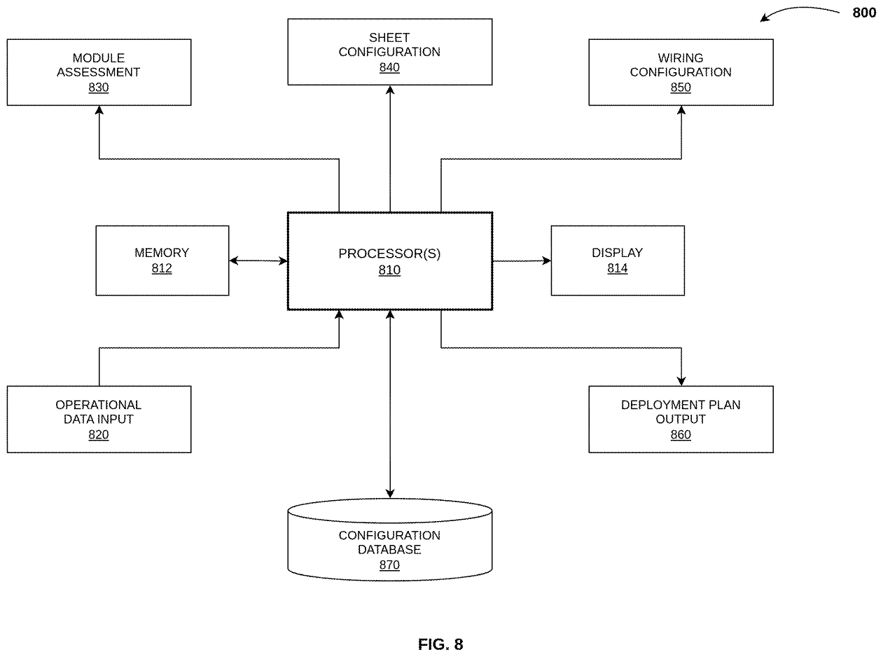

Referring to FIG. 8, a system 800 for AI-based configuration and control of solar cell module farm repowering provides algorithmic analysis and planning capabilities that enable determination of repowering parameters based on operational data from extant solar cell modules within a solar cell module farm. The system 800 ties algorithmic operations to specific physical outcomes, with the analysis operating on real-world sensor data from physical solar modules and the output being a concrete deployment plan that drives physical deployment of flexible perovskite solar cell module sheets across the farm. The system 800 enables farm operators to leverage computational analysis to determine which extant modules to repower, how to configure the flexible perovskite solar cell module sheets for deployment, and how to configure the electrical connections within the solar cell module farm wiring 914 to integrate the deployed flexible sheets with the existing inverter infrastructure. The system 800 addresses the complexity of repowering decisions across large solar cell module farms that may comprise hundreds or thousands of extant solar cell modules having varying performance characteristics, degradation histories, and electrical configurations.

With continued reference to FIG. 8, the system 800 includes a processor 810 that serves as the central processing unit for executing the algorithmic analysis and configuration operations of the system 800. The processor 810 may comprise one or more microprocessors, digital signal processors, application-specific integrated circuits, field-programmable gate arrays, or other processing elements capable of executing the computational operations involved in analyzing operational data from extant solar cell modules and generating repowering configuration parameters. The processor 810 receives input data from various sources within the solar cell module farm, processes the input data according to algorithmic instructions stored in memory, and generates output data that specifies the configuration parameters for the repowering operation. The processor 810 may execute machine learning algorithms, optimization algorithms, rule-based decision systems, or combinations thereof to analyze the operational data and determine the repowering parameters that achieve desired objectives such as maximizing energy production, minimizing deployment cost, or balancing multiple operational factors according to operator-specified priorities.

The system 800 further includes a memory 812 coupled to the processor 810, with the memory 812 storing instructions for executing repowering configuration operations. The memory 812 may comprise volatile memory such as random access memory for storing data and instructions during active processing operations, non-volatile memory such as flash memory or solid-state storage for persistent storage of algorithmic instructions and configuration data, or combinations of volatile and non-volatile memory types. The instructions stored in the memory 812, when executed by the processor 810, cause the processor 810 to perform the algorithmic analysis operations that determine which extant modules to repower, the dimensions and configurations of flexible perovskite solar cell module sheets, and the electrical connection configurations within the solar cell module farm wiring. The memory 812 may store multiple algorithmic modules corresponding to different analysis functions, with the processor 810 invoking the appropriate algorithmic modules based on the current stage of the configuration process and the specific analysis being performed.

The system 800 includes a display 814 coupled to the processor 810 for presenting configuration parameters and deployment data to an operator. The display 814 may comprise a liquid crystal display, an organic light-emitting diode display, or other display technology capable of presenting visual information to the operator, and the display 814 may be integrated into a control console, a portable computing device, or a dedicated monitoring station within the solar cell module farm control infrastructure. The display 814 enables the operator to view the results of the algorithmic analysis performed by the processor 810, including identification of extant modules recommended for repowering, proposed flexible sheet configurations, proposed wiring configurations, and the deployment sequence for progressive repowering of the farm. The display 814 may present graphical representations of the solar cell module farm layout similar to the progressive deployment farm layout 1000 described previously with reference to FIG. 10, with visual indicators distinguishing between modules recommended for repowering and modules that may continue operating in their original state. The operator may interact with the system 800 through input devices coupled to the processor 810 to modify configuration parameters, approve or reject proposed configurations, and initiate deployment operations based on the analysis results presented on the display 814.

With continued reference to FIG. 8, the system 800 receives real-world data through an operational data input 820, which provides operational data from extant solar cell modules in the farm. The operational data input 820 serves as the interface through which the system 800 receives sensor data, monitoring data, and historical records from the solar cell modules 310 within the solar power system 300 described previously with reference to FIG. 3, or from extant solar cell modules within other solar cell module farm installations. The operational data provided through the operational data input 820 includes historical power output data that records the electrical energy production of each extant solar cell module over time, enabling the processor 810 to identify trends in performance and to compare current output levels against historical baselines and original rated capacities. The operational data further includes degradation rates that quantify the rate at which each extant solar cell module has experienced performance decline over its operational lifetime, with degradation rates being calculated from the historical power output data and expressed as percentage decline per year or other time-normalized metrics. The operational data also includes fault detection signals that indicate the occurrence of faults, failures, or anomalous conditions within individual extant solar cell modules, such as open-circuit faults in individual cells, bypass diode activations, ground faults, arc faults, or other detectable fault conditions that affect module performance or safety.

The operational data input 820 may further provide farm layout information that describes the physical configuration and module positions within the solar cell module farm, including the spatial arrangement of extant solar cell modules in rows and columns, the grouping of modules into strings and arrays, the routing of the solar cell module farm wiring 914 between modules and inverters, and the positions of the inverter 1 330, the inverter 2 332, and other power conversion equipment within the farm electrical infrastructure. The farm layout information enables the processor 810 to consider spatial relationships between extant solar cell modules when determining the deployment sequence for progressive repowering, as adjacent modules may be repowered together to form contiguous solar energy collection regions as described previously with reference to the progressive deployment farm layout 1000 shown in FIG. 10. The operational data input 820 may receive data from monitoring systems already installed within the solar cell module farm, from portable measurement equipment used during site assessment operations, from satellite or aerial imagery analysis systems, or from manual data entry by operators who have conducted physical inspections of the extant solar cell modules.

The processor 810 executes AI and algorithmic analysis through three configuration functions that collectively determine the parameters for the repowering operation. A module assessment 830 represents the first configuration function, which determines which extant modules to repower based on performance degradation and other factors derived from the operational data received through the operational data input 820. The module assessment 830 analyzes the historical power output, degradation rates, and fault detection signals for each extant solar cell module within the farm to identify modules that are candidates for repowering based on criteria such as performance decline below a threshold level, degradation rate exceeding a threshold rate, occurrence of fault conditions, or age of the module relative to expected operational lifetime. The module assessment 830 may rank the extant solar cell modules according to repowering priority, with modules exhibiting the greatest performance degradation or the highest fault frequency being assigned higher priority for repowering than modules that continue to operate at or near original performance levels. The module assessment 830 may also consider economic factors such as the cost of repowering each module, the expected energy production increase from repowering, and the payback period for the repowering investment, enabling the processor 810 to identify modules for which repowering provides the greatest return on investment.

A sheet configuration 840 represents the second configuration function executed by the processor 810, which determines flexible perovskite solar cell module sheet dimensions and internal cell configurations for the flexible sheets to be deployed over the extant solar cell modules identified by the module assessment 830. The sheet configuration 840 analyzes the physical dimensions of the extant solar cell modules identified for repowering to determine the appropriate dimensions for the flexible perovskite solar cell module sheets, including whether the flexible sheets should be precut to standard dimensions matching common panel sizes or field cut to accommodate varying panel sizes, irregular panel shapes, or damaged panels as described previously with reference to the flexible sheet deployment assembly 400 shown in FIG. 4. The sheet configuration 840 further determines the internal cell configurations within each flexible perovskite solar cell module sheet, including the number of perovskite solar cells to be incorporated within each sheet, the series and parallel wiring arrangements of those cells within the sheet, and the resulting voltage and current output characteristics of each configured sheet. The internal cell configuration determined by the sheet configuration 840 affects the electrical output characteristics of the flexible perovskite solar cell module sheet, and the sheet configuration 840 may configure the internal cell wiring to produce voltage and current outputs that are compatible with the existing inverter infrastructure of the solar cell module farm or that are suitable for conditioning by the external power conditioning device 1204 described previously with reference to the PECI integration schematic 1200 shown in FIG. 12.

A wiring configuration 850 represents the third configuration function executed by the processor 810, which determines electrical connection configurations within the solar cell module farm wiring 914, including whether existing inverters should be reused or replaced. The wiring configuration 850 analyzes the electrical characteristics of the flexible perovskite solar cell module sheets as configured by the sheet configuration 840, the specifications of the existing inverter 1112 and other inverters within the solar cell module farm wiring, and the topology of the existing farm wiring to determine how the flexible perovskite solar cell module sheets should be electrically connected into the solar cell module farm wiring 914. The wiring configuration 850 may determine that the flexible perovskite solar cell module sheets should be connected in series configurations using the serial connection 1106, in parallel configurations using the parallel connection 1108, or in mixed series-parallel configurations as described previously with reference to the multi-sheet wiring topology 1100 shown in FIG. 11, with the specific connection topology being selected to match the voltage and current specifications of the existing inverters within the farm. The wiring configuration 850 may further determine whether the existing inverters within the solar cell module farm should be reused without modification, reused with the addition of the external power conditioning device 1204 to transform the electrical output of the flexible perovskite solar cell module sheets to match the inverter operating envelope, or replaced with new inverters having specifications matched to the electrical output characteristics of the deployed flexible perovskite solar cell module sheets.

With continued reference to FIG. 8, the processor 810 generates a deployment plan output 860 that drives physical deployment actions, including a deployment sequence for progressive repowering of the farm. The deployment plan output 860 represents the concrete output of the algorithmic analysis performed by the processor 810, with the deployment plan output 860 specifying the actionable parameters that guide the physical deployment of flexible perovskite solar cell module sheets across the solar cell module farm. The deployment plan output 860 may specify which extant modules are to be repowered, as determined by the module assessment 830, along with the sequence in which those modules are to be repowered during the progressive deployment operation illustrated by the deployment sequence direction 1006 in the progressive deployment farm layout 1000 described previously with reference to FIG. 10. The deployment plan output 860 may further specify the dimensions and internal cell configurations of the flexible perovskite solar cell module sheets to be deployed over each identified extant module, as determined by the sheet configuration 840, enabling procurement or manufacturing of flexible sheets having the specified configurations. The deployment plan output 860 may also specify the electrical connection configurations to be implemented during deployment, as determined by the wiring configuration 850, including the series and parallel connection topologies, the connector types to be used, and whether external power conditioning devices are to be installed.

The deployment plan output 860 drives physical deployment actions, with the connection between the algorithmic analysis performed by the processor 810 and the physical deployment operations demonstrating that the system 800 is not merely an abstract data analysis tool but drives specific physical transformations in the solar cell module farm. The physical deployment actions driven by the deployment plan output 860 include the deployment of flexible perovskite solar cell module sheets directly on the surfaces of extant solar cell modules as described previously with reference to the flexible sheet deployment assembly 400 shown in FIG. 4, the stabilization of the deployed flexible sheets using stabilization elements as described previously with reference to the deactivated panel assembly 900 shown in FIG. 9, the disconnection of extant solar cell modules from the solar cell module farm wiring 914, and the connection of the flexible perovskite solar cell module sheets into the solar cell module farm wiring 914 via sheet wiring connections 912. The deployment plan output 860 may be provided to deployment personnel through the display 814, transmitted to mobile devices carried by field installation teams, or integrated with automated deployment equipment that executes portions of the physical deployment actions according to the parameters specified in the deployment plan output 860.

The system 800 includes a configuration database 870 that stores configuration parameters, predefined electrical profiles, and control settings used by the processor 810 during analysis and plan generation. The configuration database 870 may be stored in the memory 812 or in separate storage media coupled to the processor 810, and the configuration database 870 provides persistent storage

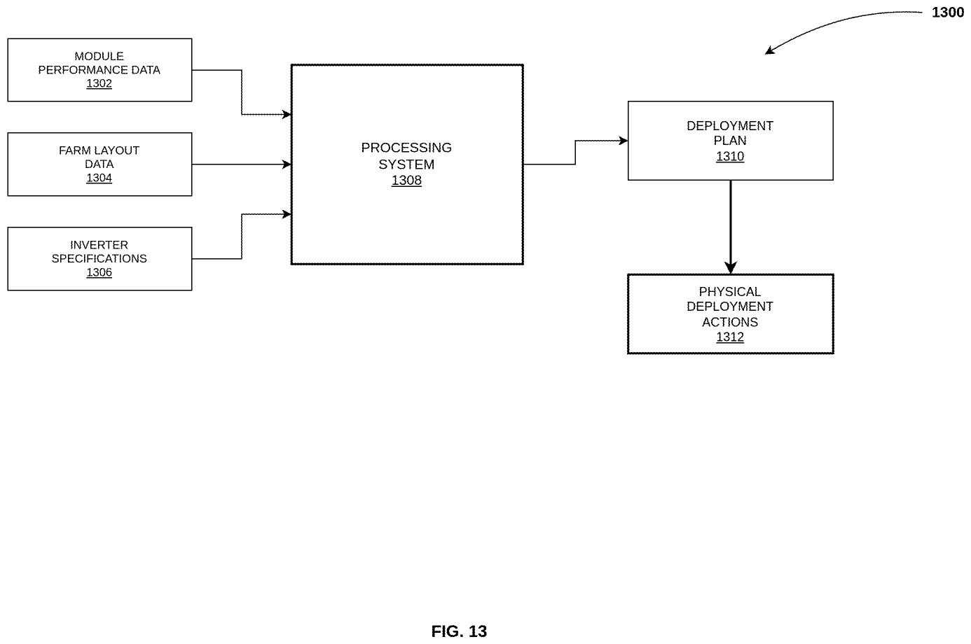

Referring to FIG. 13, an AI configuration control system 1300 provides an alternative embodiment for determining repowering parameters for a solar cell module farm, with the AI configuration control system 1300 illustrating the data flow from input sources through algorithmic processing to physical deployment outcomes. The AI configuration control system 1300 demonstrates the connection between computational analysis and physical transformation of the solar cell module farm, with the system receiving operational and configuration data from multiple sources, processing that data through algorithmic analysis, and generating output that drives concrete physical deployment actions rather than merely producing abstract analytical results. The AI configuration control system 1300 may operate in conjunction with or as an alternative to the system 800 described previously with reference to FIG. 8, with the AI configuration control system 1300 providing a streamlined representation of the data flow and processing architecture that enables determination of repowering parameters for solar cell module farms of varying sizes and configurations.

With continued reference to FIG. 13, the AI configuration control system 1300 receives input data from three data sources that collectively provide the information needed to determine repowering configuration parameters for the solar cell module farm. Module performance data 1302 provides operational data from extant solar cell modules within the farm, including historical power output records that document the electrical energy production of each extant solar cell module over the operational lifetime of the module, and degradation rates that quantify the rate at which each extant solar cell module has experienced performance decline relative to original rated capacity or initial measured performance. The module performance data 1302 may be derived from monitoring systems installed within the solar cell module farm, such as string-level monitoring equipment, module-level power electronics with integrated monitoring capabilities, or central data acquisition systems that collect performance data from sensors distributed throughout the farm. The historical power output data within the module performance data 1302 enables identification of extant solar cell modules that have experienced performance decline below threshold levels that warrant repowering, while the degradation rates enable prediction of future performance trajectories and identification of modules that are approaching performance thresholds even if current output remains above minimum acceptable levels. The module performance data 1302 may further include fault detection records, maintenance history, and other operational parameters that inform the repowering analysis performed by the AI configuration control system 1300.

Farm layout data 1304 provides the physical configuration and module positions within the solar cell module farm, enabling the AI configuration control system 1300 to consider spatial relationships between extant solar cell modules when determining repowering parameters. The farm layout data 1304 may include the geographic coordinates or relative positions of each extant solar cell module within the farm, the arrangement of modules in rows, columns, or other spatial configurations, the grouping of modules into strings and arrays for electrical collection purposes, and the routing of the solar cell module farm wiring 914 between modules and power conversion equipment. The farm layout data 1304 enables the AI configuration control system 1300 to determine deployment sequences that account for physical access constraints, to identify adjacent modules that may be repowered together to form contiguous solar energy collection regions as described previously with reference to the progressive deployment farm layout 1000 shown in FIG. 10, and to optimize the deployment sequence direction 1006 based on factors such as minimizing travel distances for deployment personnel, coordinating with existing maintenance schedules, or prioritizing sections of the farm based on performance characteristics. The farm layout data 1304 may be derived from as-built documentation of the solar cell module farm, from geographic information system databases, from aerial or satellite imagery analysis, or from site survey data collected during assessment of the farm for repowering.

Inverter specifications 1306 provides the operating parameters of existing inverters within the solar cell module farm wiring, enabling the AI configuration control system 1300 to determine electrical connection configurations that maintain compatibility with the existing inverter infrastructure. The inverter specifications 1306 may include the input voltage range over which each existing inverter operates efficiently, the maximum input current capacity of each existing inverter, the maximum power point tracking voltage windows, the number of input channels or string connections supported by each existing inverter, and other electrical parameters that define the operating envelope within which the existing inverters are designed to function. The inverter specifications 1306 enables the AI configuration control system 1300 to determine whether the flexible perovskite solar cell module sheets should be configured in series connections, parallel connections, or mixed series-parallel configurations to match the voltage and current specifications of the existing inverters, as described previously with reference to the multi-sheet wiring topology 1100 shown in FIG. 11. The inverter specifications 1306 further enables the AI configuration control system 1300 to determine whether the existing inverters may be reused without modification, whether the external power conditioning device 1204 described previously with reference to the PECI integration schematic 1200 shown in FIG. 12 should be employed to transform the electrical output of the flexible perovskite solar cell module sheets to match the inverter operating envelope, or whether replacement of existing inverters with new inverters having specifications matched to the flexible perovskite solar cell module sheet output characteristics would be advantageous. The inverter specifications 1306 may be derived from manufacturer datasheets, from commissioning records of the original solar cell module farm installation, or from field measurements of the existing inverter operating characteristics.

With continued reference to FIG. 13, a processing system 1308 receives the input data from the module performance data 1302, the farm layout data 1304, and the inverter specifications 1306, and performs algorithmic analysis to determine repowering configuration parameters based on the received input data. The processing system 1308 comprises one or more processors coupled to a memory storing instructions that, when executed by the one or more processors, perform the algorithmic analysis operations that transform the input data into actionable repowering parameters. The processing system 1308 may comprise computing hardware similar to the processor 810 and the memory 812 described previously with reference to the system 800 shown in FIG. 8, with the processing system 1308 executing machine learning algorithms, optimization algorithms, rule-based decision systems, or combinations thereof to analyze the operational data and determine the repowering parameters that achieve desired objectives. The processing system 1308 may perform module assessment functions similar to the module assessment 830 described previously with reference to FIG. 8 to determine which extant modules to repower based on the module performance data 1302, sheet configuration functions similar to the sheet configuration 840 to determine flexible perovskite solar cell module sheet dimensions and internal cell configurations, and wiring configuration functions similar to the wiring configuration 850 to determine electrical connection configurations within the solar cell module farm wiring based on the inverter specifications 1306. The algorithmic analysis performed by the processing system 1308 integrates the information from all three input data sources to generate comprehensive repowering parameters that account for module performance characteristics, spatial layout constraints, and electrical compatibility requirements.

The processing system 1308 generates a deployment plan 1310 that specifies the actionable parameters for the repowering operation based on the algorithmic analysis of the input data. The deployment plan 1310 specifies which extant modules to repower, with the selection being based on the analysis of the module performance data 1302 to identify modules exhibiting performance degradation, elevated fault rates, or other characteristics that indicate repowering would provide operational or economic benefit. The deployment plan 1310 further specifies dimensions and configurations of flexible perovskite solar cell module sheets to be deployed over the identified extant modules, including whether the flexible sheets should be precut to standard dimensions or field cut to accommodate varying panel sizes, and including the internal cell wiring configurations that determine the voltage and current output characteristics of each flexible sheet. The deployment plan 1310 also specifies electrical connection configurations within the solar cell module farm wiring, including the series and parallel connection topologies to be implemented between multiple flexible perovskite solar cell module sheets as described previously with reference to the multi-sheet wiring topology 1100 shown in FIG. 11, and including whether the external power conditioning device 1204 should be employed to transform the electrical output of the flexible sheets to match the operating envelope of the existing inverters. The deployment plan 1310 additionally specifies a deployment sequence for progressive repowering of the farm, with the deployment sequence defining the order in which extant modules are to be repowered during the progressive deployment operation and accounting for factors such as physical access constraints derived from the farm layout data 1304, performance priorities derived from the module performance data 1302, and electrical grouping considerations derived from the inverter specifications 1306.

The deployment plan 1310 drives physical deployment actions 1312, as indicated by the connection between the deployment plan 1310 and the physical deployment actions 1312 in FIG. 13. The physical deployment actions 1312 represent the concrete physical operations that transform the solar cell module farm from its original configuration to the repowered configuration, with the physical deployment actions 1312 being driven by the parameters specified in the deployment plan 1310 rather than being determined independently of the algorithmic analysis performed by the processing system 1308. The physical deployment actions 1312 include the deployment of flexible perovskite solar cell module sheets directly on the surfaces of extant solar cell modules as described previously with reference to the flexible sheet deployment assembly 400 shown in FIG. 4, with the specific extant modules receiving deployed flexible sheets being those identified in the deployment plan 1310. The physical deployment actions 1312 further include the stabilization of the deployed flexible perovskite solar cell module sheets on the extant solar cell modules using stabilization elements as described previously with reference to the deactivated panel assembly 900 shown in FIG. 9, with the stabilization securing the flexible sheets in direct contact with the surfaces of the extant modules. The physical deployment actions 1312 also include the electrical disconnection of extant solar cell modules from the solar cell module farm wiring 914 and the connection of the flexible perovskite solar cell module sheets into the solar cell module farm wiring 914 via sheet wiring connections 912, with the electrical connection configurations being implemented according to the specifications in the deployment plan 1310.

The connection from the deployment plan 1310 to the physical deployment actions 1312 demonstrates that the AI configuration control system 1300 is not merely an abstract data analysis tool but drives specific physical transformations in the solar cell module farm. The algorithmic analysis performed by the processing system 1308 operates on real-world data from physical solar modules within the farm, as provided through the module performance data 1302, the farm layout data 1304, and the inverter specifications 1306, and the output of that algorithmic analysis is a concrete deployment plan 1310 that specifies actionable parameters for physical deployment operations. The physical deployment actions 1312 driven by the deployment plan 1310 result in tangible changes to the solar cell module farm, including the physical presence of flexible perovskite solar cell module sheets deployed on extant solar cell modules, the electrical reconfiguration of the solar cell module farm wiring 914 to incorporate the deployed flexible sheets, and the progressive transformation of the farm from non-repowered extant solar cell modules 1004 to repowered extant solar cell modules 1002 as the deployment sequence specified in the deployment plan 1310 is executed across the farm. The AI configuration control system 1300 thus provides a complete pathway from data acquisition through algorithmic analysis to physical transformation, enabling the repowering of solar cell module farms to be performed according to parameters determined through computational optimization rather than through manual assessment and ad hoc decision-making.

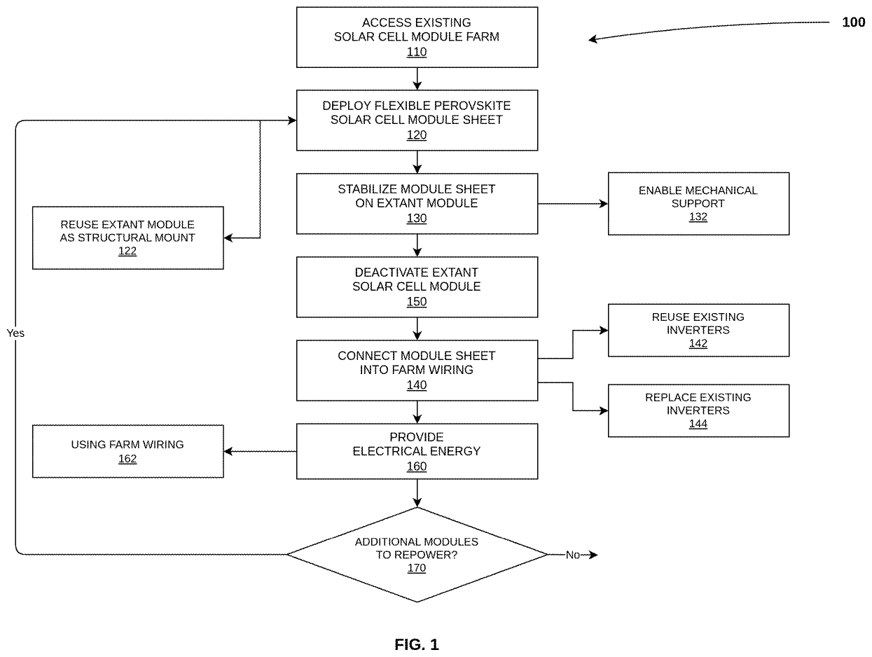

Referring to FIG. 1, a method 100 for repowering a solar cell module farm illustrates the sequence of operations for deploying flexible perovskite solar cell module sheets over extant solar cell modules within an existing solar cell module farm installation. The method 100 provides a systematic approach to repowering that enables the solar cell module farm to continue producing electrical energy from non-repowered extant solar cell modules during the repowering process, while progressively deploying flexible perovskite solar cell module sheets across the farm to increase generation capacity or restore performance of degraded, failing, or failed modules. The method 100 leverages the existing physical infrastructure of the solar cell module farm, including the extant solar cell modules and their associated physical support structures, without requiring structural reinforcement or modification to accommodate the deployed flexible perovskite solar cell module sheets.

The method 100 begins with a step 110, where an existing solar cell module farm is accessed. The step 110 encompasses the initial activities involved in preparing for the repowering operation, including gaining physical access to the solar cell module farm site, assessing the condition of the extant solar cell modules within the farm, and identifying the modules to be repowered during the deployment operation. The existing solar cell module farm accessed in the step 110 may comprise a solar power system similar to the solar power system 300 described previously with reference to FIG. 3, with multiple solar cell modules 310 arranged in a distributed configuration and connected to inverters such as the inverter 1 330 and the inverter 2 332 through the solar cell module farm wiring 914. The step 110 may involve coordination with farm operators, review of operational data such as the module performance data 1302 described previously with reference to the AI configuration control system 1300 shown in FIG. 13, and preparation of deployment equipment and materials including the flexible perovskite solar cell module sheets to be deployed.

With continued reference to FIG. 1, the method 100 proceeds from the step 110 to a step 120, where a flexible perovskite solar cell module sheet is deployed over at least one extant solar cell module within the solar cell module farm. The step 120 corresponds to the deploying operation in which a first flexible perovskite solar cell module sheet is deployed over an extant solar cell module in the solar cell module farm, with the first flexible perovskite solar cell module sheet being deployed directly on a surface of the extant solar cell module as described previously with reference to the flexible sheet deployment assembly 400 shown in FIG. 4. The first flexible perovskite solar cell module sheet has a weight sufficiently low that physical support structures supporting the extant solar cell module support both the extant solar cell module and the first flexible perovskite solar cell module sheet without structural reinforcement, enabling the deployment to proceed without modification to the support frame 312, the pivot joint 316, the support post 318, or other physical support structures of the existing solar cell module farm. The extant solar cell module over which the first flexible perovskite solar cell module sheet is deployed may comprise one or more of a functional, degraded, failing, or failed solar cell module, providing flexibility to address modules in various operational states during the repowering operation.

The first flexible perovskite solar cell module sheet may be produced in a roll format having a bend radius between 5 centimeters and 50 centimeters enabling transport in a rolled configuration, as described previously with reference to the flexible sheet deployment assembly 400 shown in FIG. 4. The first flexible perovskite solar cell module sheet may be one of precut or field cut to fit atop the extant solar cell module, with precut sheets being manufactured to standard panel dimensions and field cut sheets being cut on site to accommodate varying panel sizes, irregular panel shapes, or damaged panels. The first flexible perovskite solar cell module sheet may be transported in compact rolls and unrolled directly onto the surface of the extant solar cell module during the step 120, with the roll-based deployment approach enabling efficient handling and positioning of the flexible sheet on the extant module surface. During the step 120, the solar cell module farm continues to provide electrical energy from non-repowered extant solar cell modules, as the deployment operation affects only the specific extant solar cell module being repowered while the remaining modules in the farm continue to generate electrical energy through the existing solar cell module farm wiring 914.

A step 122 branches from the step 120, indicating reuse of an extant module as a structural mount for the flexible perovskite solar cell module sheet. The step 122 reflects the configuration in which the extant solar cell module serves as a rigid mounting surface that provides mechanical support for the deployed flexible perovskite solar cell module sheet, as described previously with reference to the deactivated panel assembly 900 shown in FIG. 9. The reuse of the extant module as a structural mount eliminates the need to remove the extant solar cell module from the physical support structure 908, reducing labor costs, disposal requirements, and disruption to the solar cell module farm during the repowering operation. The extant solar cell module remains physically in place following deployment of the flexible perovskite solar cell module sheet, with the rigid structure of the extant module providing the foundation upon which the lightweight flexible sheet rests and operates throughout the operational life of the repowered assembly.

Following the deployment in the step 120, the method 100 moves to a step 130, where the flexible perovskite solar cell module sheet is stabilized on the extant solar cell module. The step 130 corresponds to the stabilizing operation in which the first flexible perovskite solar cell module sheet is stabilized on the extant solar cell module using a stabilization element, with the stabilization element securing the first flexible perovskite solar cell module sheet in direct contact with a surface of the extant solar cell module. The stabilizing in the step 130 may comprise one or more of applying a silicone sealant adhesive between the first flexible perovskite solar cell module sheet and the extant solar cell module, mechanically attaching the first flexible perovskite solar cell module sheet to the extant solar cell module using one or more of mounting brackets, screws with washers, and framing brackets, and removable attachment comprising Velcro strips, as described previously with reference to the stabilization element 906 shown in FIG. 9. The stabilizing enables direct contact between the first flexible perovskite solar cell module sheet and the surface of the extant solar cell module, maintaining the direct contact configuration throughout the operational life of the repowered assembly despite environmental conditions such as wind loading, thermal expansion and contraction, and precipitation.

A step 132 branches from the step 130, indicating that the stabilization enables mechanical support of the flexible perovskite solar cell module sheet by the extant solar cell module. The step 132 reflects the configuration in which the extant solar cell module provides mechanical support for the first flexible perovskite solar cell module sheet, with the stabilization element 906 securing the flexible sheet in position on the extant module surface such that the rigid structure of the extant module bears the weight and environmental loads imposed on the flexible sheet. The physical support structures supporting the extant solar cell module continue to support both the extant solar cell module and the first flexible perovskite solar cell module sheet without structural modification, as the lightweight nature of the flexible perovskite solar cell module sheet enables the existing physical support structure 908 to accommodate the combined weight within the original design margins of the support infrastructure.

With continued reference to FIG. 1, the method 100 proceeds to a step 150, where the extant solar cell module is deactivated by disconnecting the extant solar cell module from the solar cell module farm wiring 914. The step 150 corresponds to the disconnecting operation in which the extant solar cell module is electrically deactivated and no longer provides electrical energy to the solar cell module farm. The disconnecting in the step 150 may comprise one or more of disconnecting output wiring at a junction box of the extant solar cell module and disconnecting connectors of the extant solar cell module from string wiring, with the disconnected connectors being capped to prevent electrical hazards and protect the disconnected wiring 910 from environmental exposure as described previously with reference to the deactivated panel assembly 900 shown in FIG. 9. Following the disconnecting in the step 150, the extant solar cell module remains in place as a structural mount for the first flexible perovskite solar cell module sheet, with the deactivated extant module continuing to provide mechanical support for the deployed flexible sheet while no longer contributing electrical energy to the solar cell module farm wiring 914.

After the deactivation in the step 150, the method 100 moves to a step 140, where the flexible perovskite solar cell module sheet is connected electrically into the solar cell module farm wiring 914. The step 140 corresponds to the connecting electrically operation in which the first flexible perovskite solar cell module sheet is connected into the solar cell module farm wiring, enabling the flexible perovskite solar cell module sheet to provide electrical energy through the existing farm wiring infrastructure. The first flexible perovskite solar cell module sheet may occupy an electrical position in the solar cell module farm wiring 914 previously occupied by the extant solar cell module, with the sheet wiring connection 912 described previously with reference to the deactivated panel assembly 900 shown in FIG. 9 replacing the disconnected wiring 910 of the extant solar cell module within the electrical architecture of the solar cell module farm. The electrical connection in the step 140 integrates the flexible perovskite solar cell module sheet into the existing string configurations, voltage levels, and current ratings of the solar cell module farm wiring 914, enabling the deployed flexible sheet to interface with the existing inverter infrastructure of the farm.

From the step 140, two branches emerge representing options for inverter management during the repowering process. A step 142 provides for reusing existing inverters within the solar cell module farm wiring 914, wherein the flexible perovskite solar cell module sheet is configured to match the voltage and current specifications of the extant solar cell module such that the existing inverter 1112 described previously with reference to the multi-sheet wiring topology 1100 shown in FIG. 11 may continue operating within designed input windows without requiring reconfiguration or replacement. The step 142 may involve configuring the internal cell wiring of the flexible perovskite solar cell module sheet in series configurations, parallel configurations, or mixed series-parallel configurations to produce voltage and current outputs that fall within the operating envelope of the existing inverters, as described previously with reference to the serial connection 1106 and the parallel connection 1108 shown in FIG. 11. A step 144 provides for replacing existing inverters within the solar cell module farm wiring 914, which may be performed when the electrical output characteristics of the deployed flexible perovskite solar cell module sheets differ substantially from the specifications of the existing inverters or when inverter replacement provides operational or economic advantages. The selection between the step 142 and the step 144 may be determined by the wiring configuration 850 described previously with reference to the system 800 shown in FIG. 8, based on analysis of the inverter specifications 1306 and the electrical characteristics of the configured flexible perovskite solar cell module sheets.

The method 100 then proceeds to a step 160, where electrical energy is provided using the flexible perovskite solar cell module sheet and the solar cell module farm wiring 914. The step 160 corresponds to the providing electrical energy operation in which the first flexible perovskite solar cell module sheet generates electrical energy from incident solar radiation and delivers that electrical energy through the solar cell module farm wiring 914 to inverters and external loads or grid connections. The flexible perovskite solar cell module sheet deployed and stabilized on the extant solar cell module converts incident light energy into electrical current through the photovoltaic conversion process within the perovskite solar cells of the flexible sheet, as described previously with reference to the perovskite solar cell 700 shown in FIG. 7, and the generated electrical energy is routed through the sheet wiring connection 912 to the solar cell module farm wiring 914 for collection and power conversion.

A step 162 branches from the step 160, indicating that electrical energy is provided using the existing farm wiring infrastructure. The step 162 reflects the configuration in which the flexible perovskite solar cell module sheet interfaces with the existing solar cell module farm wiring 914 rather than requiring installation of new wiring infrastructure, leveraging the electrical connections 320 and 322, the inverter 1 330, the inverter 2 332, and other components of the existing farm electrical architecture described previously with reference to the solar power system 300 shown in FIG. 3. The reuse of the existing farm wiring infrastructure reduces the cost and complexity of the repowering operation by eliminating the need for new wiring runs, junction boxes, combiner boxes, and other electrical infrastructure components that would otherwise be required for a new solar installation.

Following the step 160, the method 100 reaches a step 170, which determines whether additional modules remain to be repowered within the solar cell module farm. The step 170 provides a decision point that enables progressive deployment of flexible perovskite solar cell module sheets across the solar cell module farm, with the method 100 looping back to the step 120 for deployment of additional flexible sheets when additional modules remain to be repowered. The progressive deployment loop enabled by the step 170 allows the solar cell module farm to continue producing electrical energy from non-repowered extant solar cell modules while additional modules are repowered incrementally, as illustrated by the progressive deployment farm layout 1000 described previously with reference to FIG. 10. If no additional modules remain to be repowered, the method 100 concludes, with the solar cell module farm operating in its repowered configuration with flexible perovskite solar cell module sheets deployed across the identified extant solar cell modules. The progressive deployment capability provided by the step 170 enables farm operators to manage the repowering process according to operational constraints, budget availability, and maintenance schedules, with the pace of deployment being adjustable based on factors such as available installation personnel, equipment delivery schedules, weather conditions, and grid demand patterns.

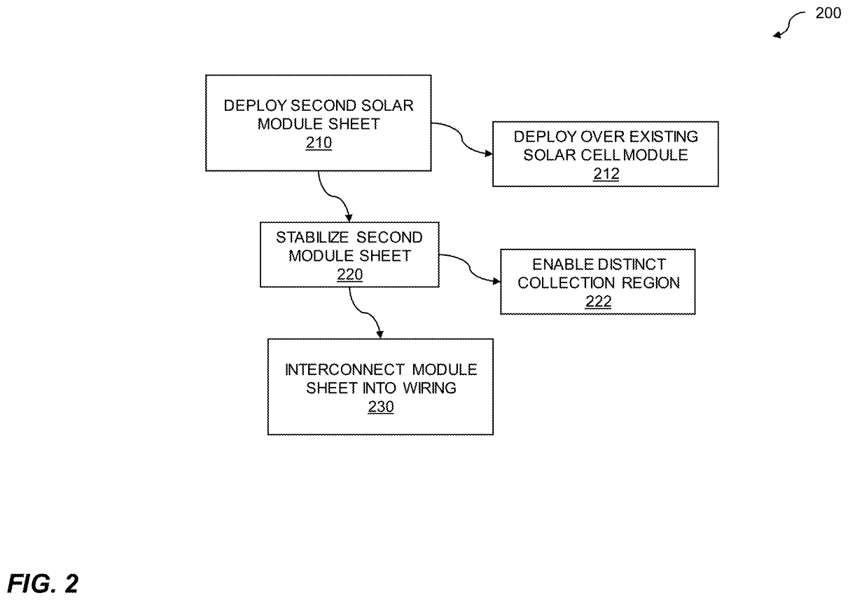

Referring to FIG. 2, a method 200 for deploying a second solar module sheet illustrates the sequence of operations for adding a supplementary flexible perovskite solar cell module sheet to an existing solar installation that has already received deployment of a first flexible perovskite solar cell module sheet as described previously with reference to the method 100 shown in FIG. 1. The method 200 provides a systematic approach for extending the repowering operation across multiple extant solar cell modules within a solar cell module farm, enabling progressive deployment of flexible perovskite solar cell module sheets while the farm continues to produce electrical energy from non-repowered extant solar cell modules. The method 200 encompasses deployment over existing infrastructure, stabilization to create separate collection regions, and integration into the electrical wiring system of the solar cell module farm, with each operation building upon the repowering framework established by the method 100.

The method 200 begins with a step 210, where a second solar module sheet is deployed within the solar cell module farm. The step 210 corresponds to the deploying operation in which the second flexible perovskite solar cell module sheet 1104 described previously with reference to the multi-sheet wiring topology 1100 shown in FIG. 11 is deployed over an additional extant solar cell module within the solar cell module farm. The second flexible perovskite solar cell module sheet deployed in the step 210 may be produced in a roll format similar to the first flexible perovskite solar cell module sheet, enabling transport in a compact rolled configuration and subsequent unrolling directly onto the surface of the additional extant solar cell module. The second flexible perovskite solar cell module sheet has a weight sufficiently low that the physical support structures supporting the additional extant solar cell module support both the additional extant solar cell module and the second flexible perovskite solar cell module sheet without structural reinforcement, consistent with the lightweight deployment approach described previously with reference to the flexible sheet deployment assembly 400 shown in FIG. 4.

With continued reference to FIG. 2, a step 212 branches from the step 210, indicating that the deployment of the second solar module sheet occurs over an existing solar cell module within the solar cell module farm. The step 212 reflects the configuration in which the additional extant solar cell module serves as a rigid mounting surface that provides mechanical support for the deployed second flexible perovskite solar cell module sheet, similar to the structural mount function described previously with reference to the step 122 of the method 100 shown in FIG. 1. The additional extant solar cell module over which the second flexible perovskite solar cell module sheet is deployed may comprise one or more of a functional, degraded, failing, or failed solar cell module, providing flexibility to address modules in various operational states during the progressive deployment operation. The deployment over the existing solar cell module in the step 212 leverages the existing physical infrastructure of the solar cell module farm, including the support frame 312, the pivot joint 316, and the support post 318 described previously with reference to the solar power system 300 shown in FIG. 3, without requiring structural modification to accommodate the deployed second flexible perovskite solar cell module sheet.

The method 200 proceeds from the step 210 to a step 220, where the second module sheet is stabilized on the additional extant solar cell module. The step 220 corresponds to the stabilizing operation in which the second flexible perovskite solar cell module sheet is stabilized on the additional extant solar cell module using a stabilization element, with the stabilization element securing the second flexible perovskite solar cell module sheet in direct contact with a surface of the additional extant solar cell module. The stabilizing in the step 220 may comprise one or more of applying a silicone sealant adhesive between the second flexible perovskite solar cell module sheet and the additional extant solar cell module, mechanically attaching the second flexible perovskite solar cell module sheet to the additional extant solar cell module using one or more of mounting brackets, screws with washers, and framing brackets, and removable attachment comprising Velcro strips, consistent with the stabilization approaches described previously with reference to the stabilization element 906 shown in FIG. 9. The stabilizing in the step 220 enables direct contact between the second flexible perovskite solar cell module sheet and the surface of the additional extant solar cell module, maintaining the direct contact configuration throughout the operational life of the repowered assembly.

A step 222 branches from the step 220, indicating that the stabilization enables a distinct solar energy collection region between the first flexible perovskite solar cell module sheet and the second flexible perovskite solar cell module sheet. The step 222 reflects the configuration in which the stabilizing enables distinct solar energy collection regions between the first flexible perovskite solar cell module sheet 1102 and the second flexible perovskite solar cell module sheet 1104 described previously with reference to the multi-sheet wiring topology 1100 shown in FIG. 11, with each flexible perovskite solar cell module sheet defining a separate collection region when deployed and stabilized on its respective extant solar cell module. The distinct solar energy collection regions may be configured to form a contiguous solar energy collection region across the extant solar cell module and the additional extant solar cell module when the extant solar cell module and the additional extant solar cell module are adjacent extant solar cell modules within the solar cell module farm, as described previously with reference to the progressive deployment farm layout 1000 shown in FIG. 10. The stabilization in the step 220 secures each flexible perovskite solar cell module sheet in position on its respective extant solar cell module such that the distinct collection regions remain defined and operational throughout the progressive deployment operation.

Following the stabilization in the step 220, the method 200 moves to a step 230, where the second module sheet is interconnected into the solar cell module farm wiring 914. The step 230 corresponds to the interconnecting operation in which the second flexible perovskite solar cell module sheet is interconnected into the solar cell module farm wiring, enabling the second flexible perovskite solar cell module sheet to provide electrical energy through the existing farm wiring infrastructure in coordination with the first flexible perovskite solar cell module sheet. The interconnecting in the step 230 integrates the second flexible perovskite solar cell module sheet into the electrical architecture of the solar cell module farm, with the sheet wiring connection 912 described previously with reference to the deactivated panel assembly 900 shown in FIG. 9 coupling the output terminals of the second flexible perovskite solar cell module sheet to the solar cell module farm wiring 914. The deploying of the second flexible perovskite solar cell module sheet in the step 210 is part of a progressive deployment across the solar cell module farm, as illustrated by the deployment sequence direction 1006 in the progressive deployment farm layout 1000 described previously with reference to FIG. 10, and the solar cell module farm continues to produce electrical energy from non-repowered extant solar cell modules 1004 during the progressive deployment.

The interconnecting in the step 230 may comprise one of a serial connection, a parallel connection, or a mixed series-parallel configuration between the first flexible perovskite solar cell module sheet and the second flexible perovskite solar cell module sheet, with the selection of the connection topology depending on the voltage and current specifications of the existing inverter 1112 within the solar cell module farm wiring and the electrical output characteristics of the deployed flexible perovskite solar cell module sheets. The serial connection 1106 described previously with reference to the multi-sheet wiring topology 1100 shown in FIG. 11 increases voltage output of the combined first flexible perovskite solar cell module sheet 1102 and second flexible perovskite solar cell module sheet 1104 to form a string, with the serial connection increasing voltage by coupling the positive terminal of one flexible sheet to the negative terminal of the adjacent flexible sheet such that the voltages of the two sheets are additive. The serial connection may be employed when the voltage output of individual flexible perovskite solar cell module sheets is lower than the input voltage requirements of the existing inverter 1112, enabling the combined string voltage to match the inverter operating envelope.

The parallel connection 1108 described previously with reference to the multi-sheet wiring topology 1100 shown in FIG. 11 increases current output while maintaining voltage at an individual sheet level, with the parallel connection coupling the positive terminals of the first flexible perovskite solar cell module sheet and the second flexible perovskite solar cell module sheet together and coupling the negative terminals together such that the currents from the two sheets are additive while the voltage remains at the individual sheet voltage level. The parallel connection may be employed when the voltage output of individual flexible perovskite solar cell module sheets matches the input voltage requirements of the existing inverter 1112, enabling increased current capacity to be delivered to the solar cell module farm wiring 1110 without exceeding the voltage specifications of the existing inverter.

The mixed series-parallel configuration combines serial connections and parallel connections to achieve voltage and current characteristics that match the operating envelope of the existing inverter 1112 within the solar cell module farm wiring. In a mixed series-parallel configuration, multiple flexible perovskite solar cell module sheets may be connected in series to form strings having the desired string voltage, and multiple strings may then be connected in parallel to increase the total current capacity delivered to the solar cell module farm wiring. The mixed series-parallel configuration provides flexibility to accommodate various inverter input specifications and farm wiring configurations that may be encountered across different solar cell module farm installations, enabling the repowering system to leverage the existing inverter infrastructure without requiring inverter replacement in a wide range of deployment scenarios. The wiring configuration 850 described previously with reference to the system 800 shown in FIG. 8 may determine the appropriate connection topology for the interconnecting in the step 230 based on analysis of the inverter specifications 1306 and the electrical characteristics of the configured flexible perovskite solar cell module sheets.

The connecting electrically operation described previously with reference to the method 100 may comprise various approaches for integrating the flexible perovskite solar cell module sheet into the solar cell module farm wiring while maintaining compatibility with the existing inverter infrastructure of the solar cell module farm. The selection of a particular electrical connection approach depends on factors including the native electrical output characteristics of the flexible perovskite solar cell module sheet, the operating specifications of the existing inverters within the solar cell module farm wiring, the wiring topology of the existing farm electrical architecture, and the operational preferences of the farm operator. Two primary approaches may be employed for the connecting electrically operation: conditioning the electrical output of the flexible perovskite solar cell module sheet using an external power conditioning device, or configuring the flexible perovskite solar cell module sheet to directly match the voltage and current specifications of the extant solar cell module being replaced such that existing inverters may be reused without modification.

The connecting electrically may comprise conditioning an electrical output of the first flexible perovskite solar cell module sheet to match an operating envelope of an existing inverter within the solar cell module farm wiring. The operating envelope of the existing inverter comprises the range of input voltage levels, input current levels, and power levels over which the existing inverter is designed to operate efficiently and safely, with the operating envelope being determined by the design specifications of the existing inverter as originally installed in the solar cell module farm to receive electrical input from the original extant solar cell modules. The conditioning transforms the native electrical output of the first flexible perovskite solar cell module sheet such that the conditioned output falls within the operating envelope of the existing inverter, enabling the existing inverter to continue operating within its designed input windows without requiring reconfiguration or replacement. The conditioning approach provides flexibility to accommodate situations in which the native electrical output characteristics of the first flexible perovskite solar cell module sheet differ from the specifications expected by the existing inverter, enabling the repowering system to be deployed across solar cell module farms having various inverter types and configurations.

The conditioning comprises one or more of voltage step-up, voltage step-down, current limiting, and output stabilization, with the specific conditioning functions being selected based on the mismatch between the native electrical output characteristics of the first flexible perovskite solar cell module sheet and the operating envelope of the existing inverter within the solar cell module farm wiring. Voltage step-up, also referred to as boost conversion, increases the voltage level of the electrical output from the first flexible perovskite solar cell module sheet to a higher voltage level that falls within the input voltage range of the existing inverter, which may be employed when the native output voltage of the first flexible perovskite solar cell module sheet is lower than the minimum input voltage threshold of the existing inverter. Voltage step-down, also referred to as buck conversion, decreases the voltage level of the electrical output from the first flexible perovskite solar cell module sheet to a lower voltage level that falls within the input voltage range of the existing inverter, which may be employed when the native output voltage of the first flexible perovskite solar cell module sheet exceeds the maximum input voltage threshold of the existing inverter or when operation at a lower voltage within the inverter operating envelope provides efficiency advantages.

Current limiting restricts the current level of the electrical output from the first flexible perovskite solar cell module sheet to a maximum current level that does not exceed the current handling capacity of the existing inverter input stage, protecting the existing inverter from overcurrent conditions that may otherwise cause damage or trigger protective shutdown of the inverter. Output stabilization reduces variations in the voltage and current output of the first flexible perovskite solar cell module sheet that may result from fluctuations in incident solar irradiance, temperature changes, or other transient conditions, providing a more stable electrical input to the existing inverter that may improve inverter efficiency and reduce stress on inverter components. Output stabilization may be achieved through filtering circuitry such as capacitive filtering to smooth voltage ripple, inductive filtering to reduce current transients, or combinations of capacitive and inductive filtering elements. Output stabilization may also be achieved through active regulation circuitry that monitors output voltage and current and adjusts converter operation to maintain stable output levels, with feedback control loops that sense output voltage and current and adjust switching parameters of the DC-DC converter circuitry within the external power conditioning device to compensate for variations in input from the flexible perovskite solar cell module sheet. The conditioning may perform combinations of voltage step-up, voltage step-down, current limiting, and output stabilization depending on the specific requirements of the particular installation, with the conditioning functions being configured to transform the native electrical output of the first flexible perovskite solar cell module sheet into a conditioned output that falls within the operating envelope of the existing inverter.

The conditioning is performed by an external power conditioning device positioned between the first flexible perovskite solar cell module sheet and the solar cell module farm wiring. The external power conditioning device receives the native electrical output from the first flexible perovskite solar cell module sheet at its input terminals and produces the conditioned electrical output at its output terminals, with the conditioned output being delivered to the solar cell module farm wiring for routing to the existing inverter. The positioning of the external power conditioning device between the first flexible perovskite solar cell module sheet and the solar cell module farm wiring enables the external power conditioning device to intercept and transform the electrical output before the electrical energy enters the existing farm wiring infrastructure, ensuring that the electrical characteristics presented to the solar cell module farm wiring and the existing inverter conform to the expected specifications. The external power conditioning device may incorporate DC-DC converter circuitry, such as buck converters, boost converters, buck-boost converters, or other power conversion topologies, to perform the voltage transformation functions, along with current sensing and limiting circuitry to perform the current limiting function and filtering or regulation circuitry to perform the output stabilization function.

The external power conditioning device may be physically located in proximity to the first flexible perovskite solar cell module sheet, such as mounted on the physical support structure that supports the extant solar cell module over which the first flexible perovskite solar cell module sheet is deployed, enabling short wiring runs between the flexible sheet output terminals and the external power conditioning device input terminals. In other cases, the external power conditioning device may be located at a central collection point within the solar cell module farm where multiple flexible perovskite solar cell module sheets feed into a shared power conditioning stage, enabling a single external power conditioning device to condition the combined output of multiple flexible sheets before delivery to the solar cell module farm wiring. The external power conditioning device may be configurable to match one of a plurality of predefined electrical profiles corresponding to different inverter types, enabling a single external power conditioning device design to be deployed across multiple solar cell module farm installations having different existing inverter types by selecting the appropriate predefined electrical profile during installation or commissioning.

As an alternative to the conditioning approach, the connecting electrically may comprise reusing one or more existing inverters within the solar cell module farm wiring without requiring an external power conditioning device. The reuse of existing inverters is enabled by configuring the first flexible perovskite solar cell module sheet to produce electrical output characteristics that directly match the specifications expected by the existing inverters, eliminating the need for intermediate power conditioning between the flexible sheet and the solar cell module farm wiring. The first flexible perovskite solar cell module sheet is configured to match voltage and current specifications of the extant solar cell module, with the voltage and current specifications of the extant solar cell module being the electrical output characteristics that the existing inverters were designed to receive from the original extant solar cell modules within the solar cell module farm. By configuring the first flexible perovskite solar cell module sheet to replicate the voltage and current specifications of the extant solar cell module being replaced, the first flexible perovskite solar cell module sheet presents electrical characteristics to the solar cell module farm wiring and the existing inverters that fall within the designed input windows of the existing inverters.

The configuration of the first flexible perovskite solar cell module sheet to match the voltage and current specifications of the extant solar cell module enables the one or more existing inverters to continue operating within designed input windows without requiring reconfiguration, reprogramming, or replacement of the existing inverters. The designed input windows of the existing inverters comprise the voltage ranges, current ranges, and power ranges over which the existing inverters were designed and tested to operate efficiently and reliably, with the designed input windows being established during the original design and manufacturing of the existing inverters based on the expected electrical characteristics of the solar cell modules that the inverters were intended to serve. When the first flexible perovskite solar cell module sheet is configured to match the voltage and current specifications of the extant solar cell module, the electrical output of the first flexible perovskite solar cell module sheet falls within the designed input windows of the existing inverters, enabling the existing inverters to process the electrical output from the first flexible perovskite solar cell module sheet using the same operating parameters and control algorithms that were employed for the original extant solar cell modules.

The first flexible perovskite solar cell module sheet comprises internal cell wiring in one or more of a series configuration and a parallel configuration to match the voltage and current specifications of the extant solar cell module being replaced. The internal cell wiring refers to the electrical interconnections between the individual perovskite solar cells within the first flexible perovskite solar cell module sheet, with the internal cell wiring determining how the voltage and current outputs of the individual cells are combined to produce the overall voltage and current output of the first flexible perovskite solar cell module sheet. The series configuration of the internal cell wiring connects the individual perovskite solar cells in series, with the positive terminal of one cell connected to the negative terminal of the adjacent cell, resulting in the voltages of the series-connected cells being additive while the current through the series-connected cells remains equal to the current produced by each individual cell. The series configuration increases the voltage output of the first flexible perovskite solar cell module sheet relative to the voltage of individual cells, enabling the first flexible perovskite solar cell module sheet to produce a voltage output that matches the voltage specification of the extant solar cell module.

The parallel configuration of the internal cell wiring connects the individual perovskite solar cells in parallel, with the positive terminals of the cells connected together and the negative terminals of the cells connected together, resulting in the currents from the parallel-connected cells being additive while the voltage across the parallel-connected cells remains equal to the voltage of each individual cell. The parallel configuration increases the current output of the first flexible perovskite solar cell module sheet relative to the current of individual cells, enabling the first flexible perovskite solar cell module sheet to produce a current output that matches the current specification of the extant solar cell module. The first flexible perovskite solar cell module sheet may comprise internal cell wiring in a mixed series-parallel configuration that combines series connections and parallel connections to achieve both the voltage specification and the current specification of the extant solar cell module, with groups of cells being connected in series to achieve the desired voltage and multiple series groups being connected in parallel to achieve the desired current capacity.

The internal cell wiring configuration of the first flexible perovskite solar cell module sheet may be determined during manufacturing based on the specifications of the extant solar cell modules within the target solar cell module farm, enabling production of flexible perovskite solar cell module sheets having internal cell wiring configurations matched to common extant solar cell module types. In other cases, the internal cell wiring configuration may be determined during the repowering planning process based on analysis of the specific extant solar cell modules within the particular solar cell module farm being repowered, enabling customized internal cell wiring configurations that precisely match the voltage and current specifications of the extant solar cell modules present in that installation. The flexibility to configure the internal cell wiring in series configurations, parallel configurations, or mixed series-parallel configurations enables the first flexible perovskite solar cell module sheet to be adapted to match a wide range of extant solar cell module specifications, providing compatibility with the diverse array of solar cell module types that may be encountered across different solar cell module farm installations of varying ages, manufacturers, and configurations.

The internal cell wiring configuration of the first flexible perovskite solar cell module sheet may be determined during manufacturing based on the specifications of the extant solar cell modules within the target solar cell module farm, enabling production of flexible perovskite solar cell module sheets having internal cell wiring configurations matched to common extant solar cell module types. The number of perovskite solar cells connected in series within the flexible perovskite solar cell module sheet determines the output voltage, with each perovskite solar cell contributing approximately 0.5V to 1.2V to the total voltage depending on the perovskite composition and operating conditions. The number of parallel cell groups within the flexible perovskite solar cell module sheet determines the current capacity, with each parallel group contributing its current output to the total current capacity of the sheet. During manufacturing, the target voltage and current specifications of the extant solar cell module to be replaced are used to calculate the required number of series-connected cells to achieve the target voltage and the required number of parallel groups to achieve the target current capacity. Interconnection patterns implementing the calculated series and parallel configurations are then implemented through conductive traces deposited on the flexible substrate, bus bars connecting cell groups, or ribbon conductors attached during the sheet fabrication process. In other cases, the internal cell wiring configuration may be determined during the repowering planning process based on analysis of the specific extant solar cell modules within the particular solar cell module farm being repowered, enabling customized internal cell wiring configurations that precisely match the voltage and current specifications of the extant solar cell modules present in that installation. The flexibility to configure the internal cell wiring in one or more of a series configuration and a parallel configuration to match the voltage and current specifications of the extant solar cell module enables the first flexible perovskite solar cell module sheet to be adapted to match a wide range of extant solar cell module specifications, providing compatibility with the diverse array of solar cell module types that may be encountered across different solar cell module farm installations of varying ages, manufacturers, and configurations.

Throughout this disclosure, various terms and phrases describe features of the disclosed technology. Unless explicitly defined herein or clearly limited by context, all terms and phrases are to be interpreted according to their ordinary and customary meaning as understood by a person of ordinary skill in the relevant art at the time of filing. The terms and phrases used in this specification are to be given their broadest reasonable interpretation consistent with the specification in the jurisdiction in which protection is sought.

The use of the word “a” or “an” when used in conjunction with the term “comprising” and similar open-ended transitional phrases in the claims is to be interpreted as meaning “one or more.” For example, reference to “a flexible perovskite solar cell module sheet” includes one or more flexible perovskite solar cell module sheets, reference to “an extant solar cell module” includes one or more extant solar cell modules, reference to “a stabilization element” includes one or more stabilization elements or combinations of stabilization element types, and reference to “an electrical connection” includes one or more electrical connections. The use of the term “or” is intended to be inclusive, such that “A or B” includes A alone, B alone, or both A and B together, unless explicitly stated otherwise or the context clearly requires mutual exclusion.

The transitional phrase “comprising” and its variants (“comprises,” “including,” “containing”) are open-ended and do not exclude additional, unrecited elements, steps, or components. A solar cell module repowering assembly “comprising” a set of elements permits additional elements not recited. The transitional phrase “consisting of” is closed and excludes any element, step, or component not specified in the claim. The transitional phrase “consisting essentially of” limits the scope to the specified elements, steps, or components and those that do not materially affect the basic and novel characteristics of the claimed invention.

The phrase “one or more of” followed by a list of items means any one of the items individually, any combination of two or more of the items, or all of the items. For example, “one or more of a functional, degraded, failing, or failed solar cell module” includes any single one of those conditions, any combination of those conditions across different modules in a farm, or all of those conditions. The phrase “at least one of” followed by a list of items has the same meaning as “one or more of.”

Reference throughout the specification to “one embodiment,” “an embodiment,” “some embodiments,” “in certain implementations,” “in some cases,” “in other cases,” and similar phrases means that a particular feature, structure, or characteristic described in connection with that embodiment is included in at least one embodiment of the present disclosure. Such references do not necessarily refer to the same embodiment, and the referenced features, structures, or characteristics may be combined in any suitable manner across different embodiments without limitation. The absence of a feature from a particular embodiment does not imply that the feature is incompatible with that embodiment.

The use of ordinal terms such as “first,” “second,” “third,” and the like in the claims or the specification does not by itself connote any priority, precedence, order, temporal sequence, or ranking among the elements they modify. These terms are used solely to distinguish one element or step from another. For example, a “first flexible perovskite solar cell module sheet” and a “second flexible perovskite solar cell module sheet” are distinguished by the ordinal labels and not by any implied priority, deployment order, or physical ranking. Unless the claim language or specification explicitly states a required ordering (for example, “deploying the first sheet before the second sheet”), no ordering is implied.

The terms “top,” “bottom,” “left,” “right,” “front,” “back,” “upper,” “lower,” “above,” “below,” “over,” “on,” “directly on,” and similar directional or positional terms are used for descriptive convenience with respect to the accompanying drawings and the described deployment configurations. These terms are relative to the orientation of the components as installed and do not impose absolute spatial limitations. A flexible perovskite solar cell module sheet described as being deployed “over” or “on” an extant solar cell module refers to the relative positioning of the flexible sheet with respect to the extant module surface, regardless of whether the installation is horizontal, tilted, vertical, or oriented at any other angle relative to the ground.

The use of the term “may” indicates that the described action, feature, or characteristic is possible or permitted but not mandatory. This term describes optional or alternative aspects of the disclosed technology. Similarly, the term “can” describes capability, not requirement. The use of the term “in some cases” or “in other cases” introduces alternative embodiments, each of which is illustrative and non-exclusive.

Where the specification describes a benefit, advantage, or result achieved by the disclosed technology, such as improved energy production, reduced waste, leveraging existing infrastructure, or maintaining continuous farm operation, such description is illustrative and is not intended to imply that every embodiment within the scope of the claims necessarily achieves that benefit, advantage, or result.

The use of the terms “approximately,” “substantially,” “about,” and similar terms of degree when modifying a value, dimension, condition, or relationship means within a range of tolerance that would be understood as acceptable by a person of ordinary skill in the art, taking into account the particular context, the nature of the measurement, and any precision requirements stated in the specification. Unless otherwise defined or apparent from context, “about” with respect to a numerical value means within plus or minus ten percent of the stated value. For example, a bend radius of “about 5 centimeters” encompasses bend radii from 4.5 centimeters to 5.5 centimeters.

Where a range is stated, such as “between 5 centimeters and 50 centimeters,” the range includes the recited endpoints and all values between them unless the context clearly indicates otherwise. Any sub-range within a disclosed range, and any individual value within a disclosed range, is also within the scope of the disclosure. For example, the range of 5 centimeters to 50 centimeters encompasses sub-ranges such as 10 centimeters to 30 centimeters, 15 centimeters to 25 centimeters, and all individual values within the stated range.

The term “substantially” when modifying a condition or spatial relationship (such as “substantially flat,” “substantially uniform,” or “substantially all”) means sufficiently close to the stated condition that a person of ordinary skill in the art would consider the condition to be met for the intended purpose. The term “direct contact” as used in this specification means physical contact between surfaces without an intervening air gap, structural spacer, or separation layer, though the presence of a thin adhesive layer, coating, or interface material applied to facilitate contact or stabilization does not negate direct contact.

As used herein, the term “solar cell module” refers to any photovoltaic device or assembly of photovoltaic devices configured to convert light energy into electrical energy. This definition encompasses, without limitation: crystalline silicon modules (including monocrystalline and polycrystalline silicon); thin-film modules (including cadmium telluride, copper indium gallium selenide, and amorphous silicon); perovskite modules; organic photovoltaic modules; multi-junction or tandem modules; bifacial modules; and any other photovoltaic technology, whether currently existing or hereafter developed. The term “solar cell module” includes both rigid modules mounted in frames and frameless or flexible modules, and includes modules of any wattage rating, cell count, or physical dimension.

As used herein, the term “extant solar cell module” refers to a solar cell module that has been previously installed and is currently present within a solar cell module farm, regardless of its operational status. The extant solar cell module may be functional (operating at or near original specifications), degraded (experiencing reduced performance relative to original specifications), failing (experiencing progressive loss of function), or failed (no longer producing meaningful electrical output). The term “extant” describes the physical presence and prior installation of the module, not its operational condition.

As used herein, the term “perovskite” refers to any material having a perovskite crystal structure characterized by the general formula ABX3, where A represents one or more monovalent cations (including, without limitation, methylammonium, formamidinium, cesium, rubidium, and combinations thereof), B represents one or more divalent metal cations (including, without limitation, lead, tin, germanium, and combinations thereof), and X represents one or more halide anions (including, without limitation, iodide, bromide, chloride, and combinations thereof). The term encompasses single-cation, mixed-cation, single-halide, mixed-halide, and lead-free perovskite compositions. The term further encompasses two-dimensional, quasi-two-dimensional, and three-dimensional perovskite structures.

As used herein, the term “flexible” when modifying a solar cell module sheet or photovoltaic device means that the device is capable of being bent, curved, rolled, or conformed to a surface without loss of structural integrity or functional capability at the bend radii described in the specification. The term does not require any particular minimum or maximum flexibility, thickness, or mechanical property beyond the capability to be deployed as described.

As used herein, the term “solar cell module farm” refers to any installation comprising a plurality of solar cell modules arranged for electrical energy generation, regardless of scale. The term encompasses utility-scale solar farms, commercial rooftop installations, community solar arrays, ground-mounted arrays, and any other multi-module photovoltaic installation. The term “farm” does not imply any minimum number of modules, any particular geographic area, or any particular mounting configuration.

As used herein, the term “repowering” refers to the process of restoring, increasing, or replacing the electrical energy generation capability of an existing solar cell module or solar cell module farm by deploying additional photovoltaic devices, whether by supplementing or replacing the generation function of extant solar cell modules. The term encompasses both partial repowering (addressing selected modules within a farm) and complete repowering (addressing all modules within a farm), and encompasses repowering performed in a single campaign or progressively over time.

As used herein, the term “stabilization element” refers to any physical structure, material, device, mechanism, or combination thereof that secures a flexible perovskite solar cell module sheet in position on an extant solar cell module. The term is a structural term that connotes sufficiently definite structure to a person of ordinary skill in the art. The stabilization element includes, without limitation: adhesive materials (including silicone sealant adhesives, acrylic adhesives, polyurethane adhesives, epoxy adhesives, pressure-sensitive adhesives, and other bonding agents suitable for outdoor photovoltaic environments); mechanical fasteners and attachment hardware (including mounting brackets, screws with washers, framing brackets, edge clamps, mid-clamps, corner brackets, clips, bolts, rivets, and other fastening components); removable attachment mechanisms (including hook-and-loop fastener strips such as Velcro, magnetic attachment systems, snap-fit connectors, and other re-attachable fastening systems); vacuum-based attachment systems; weight-based retention systems; and any combination of two or more of the foregoing. The selection and combination of stabilization elements may vary across different installations and different modules within a single installation without departing from the scope of the disclosure.

As used herein, the term “electrical connections” refers to any physical conductors, connectors, junction hardware, and associated components that form conductive paths between the flexible perovskite solar cell module sheet and the solar cell module farm wiring. The term encompasses, without limitation: plug-type connectors (including MC4, MC3, T4, H4, Amphenol H4, Tyco Solarlok, and any other photovoltaic connector type); direct-wire connections (including soldered, crimped, or clamped wire terminations); junction boxes and combiner boxes; bus bars, ribbon conductors, and cable assemblies; and any other means of establishing electrical conductivity between components in a photovoltaic system.

As used herein, the term “solar cell module farm wiring” refers to the existing electrical infrastructure of a solar cell module farm, including all conductors, connectors, junction boxes, combiner boxes, disconnect switches, fuses, circuit breakers, grounding conductors, monitoring wiring, and other electrical components that collectively route electrical energy from solar cell modules to inverters, transformers, meters, and grid interconnection points. The term encompasses both the DC wiring between modules and inverters and the AC wiring between inverters and external loads or the electrical grid.

As used herein, the term “inverter” refers to any power conversion device or system that converts direct current generated by photovoltaic devices into alternating current, or that otherwise conditions, transforms, or manages the electrical output of photovoltaic devices for delivery to external loads or the electrical grid. The term encompasses, without limitation: central inverters, string inverters, microinverters, power optimizers with associated inverters, hybrid inverters, battery-coupled inverters, and any other power conversion topology used in photovoltaic installations.

As used herein, the term “physical support structures” refers to any structural components that provide mechanical support, elevation, orientation, and retention for solar cell modules within a solar cell module farm. The term encompasses, without limitation: support posts, ground screws, driven piles, concrete foundations, ballasted bases, and other foundation elements; support frames, mounting rails, purlins, and racking systems; pivot joints, slew drives, linear actuators, and other tracking or orientation adjustment mechanisms; fixed-tilt mounting structures; single-axis and dual-axis tracking systems; rooftop mounting systems including ballasted, mechanically attached, and integrated mounting approaches; carport and canopy mounting structures; and any other structural system that supports solar cell modules in an installed position. The term “without structural modification” means that the existing physical support structures are not reinforced, replaced, or physically altered to accommodate the additional weight or presence of the deployed flexible perovskite solar cell module sheet, and that the existing physical support structures continue to function within their original design parameters.

As used herein, the term “external power conditioning device” refers to a device comprising power electronics circuitry positioned between a flexible perovskite solar cell module sheet and the solar cell module farm wiring, the device being configured to transform the voltage, current, or both of the electrical output of the flexible perovskite solar cell module sheet. The term is a structural term that connotes sufficiently definite structure to a person of ordinary skill in the art. The external power conditioning device includes power conversion circuitry, such as DC-DC converter circuitry including one or more of buck converters, boost converters, buck-boost converters, SEPIC converters, Cuk converters, flyback converters, and forward converters, together with associated current sensing circuitry, current limiting circuitry, voltage regulation circuitry, maximum power point tracking circuitry, and control circuitry. The external power conditioning device is distinct from the inverter to which the solar cell module farm wiring delivers electrical energy, and the external power conditioning device operates on direct current. The external power conditioning device may be a standalone unit, may be integrated with a junction box or combiner box, or may be configured as a module-level power electronics device.

No claim element in the appended claims is intended to invoke 35 U.S.C. Section 112(f) unless the element expressly uses the phrase “means for” or “step for.” The terms “element,” “device,” “module,” “sheet,” “assembly,” “system,” “unit,” “layer,” “component,” and “connection” as used in the specification and claims are structural terms that connote sufficiently definite structure to persons of ordinary skill in the art and are not intended to be interpreted as generic placeholders for “means.”

Without limiting the foregoing: the term “stabilization element” denotes a physical structure or material as defined in the section titled “Stabilization Element Definitions” above; the term “external power conditioning device” denotes a device comprising power electronics circuitry as defined in the section titled “External Power Conditioning Device Definitions” above; the term “electrical connections” denotes physical conductors and connectors as defined in the section titled “Electrical Connection and Wiring Terminology” above; and the term “flexible perovskite solar cell module sheet” denotes a flexible photovoltaic device comprising perovskite absorber material on a flexible substrate, structured as a multi-layer stack including at a minimum a transparent conductive layer, charge transport layers, a perovskite absorber layer, and electrode layers as described in connection with the perovskite solar cell 700 shown in FIG. 7 and structural equivalents thereof.

Where the specification describes a “processor” (such as the processor 810) or a “processing system” (such as the processing system 1308) as performing algorithmic functions, the corresponding structure for purposes of any Section 112(f) analysis includes any general-purpose or special-purpose computing hardware executing the algorithms described in the specification, including the module assessment 830, the sheet configuration 840, and the wiring configuration 850, which are each disclosed as algorithmic procedures implemented by the processor executing instructions stored in the memory 812.

The phrases “configured to,” “operable to,” and “adapted to” when used in connection with a system, device, component, module, or assembly mean that the element is structurally arranged, manufactured, programmed, or designed in a manner that enables it to perform the stated function. The phrase “configured to” does not require that the element perform the function at all times or in all operating modes; it requires that the element possess the structural or programmatic capability to perform the function when appropriately deployed, invoked, or activated. Unless the claim language or context clearly indicates otherwise, “configured to,” “operable to,” and “adapted to” are not terms of limitation that require any particular hardware, software, or material composition beyond what is necessary to enable the stated function. A flexible perovskite solar cell module sheet “configured for deployment directly on a surface of an extant solar cell module” is one that has the physical characteristics (flexibility, weight, dimensions) that enable such deployment. A stabilization element “configured to stabilize” the flexible sheet is one that possesses the structural or material characteristics that enable it to secure the flexible sheet in position.

Where the claims or specification use temporal or causation language such as “in response to,” “based on,” “upon,” “after,” “before,” “when,” “during,” “while,” or similar terms, these terms do not require immediate temporal succession or sole causation unless explicitly stated. “In response to” an event or condition means that the event or condition is at least one factor that triggers, causes, or contributes to the described action, but does not exclude the possibility that other events, conditions, or factors also contribute. “Based on” a value or input means that the value or input is at least one factor considered or used in the described computation or decision, but does not require that it is the sole factor. “After” an event means at some point subsequent to the event, with no implied maximum delay. “During” a process means at some point within the temporal span of the process, with no implied requirement that the described action occupy the entire duration. These terms describe causal and temporal relationships at a functional level and do not impose precise timing constraints unless the specification or claims explicitly provide such constraints.

Where the specification describes a particular means, mechanism, component, material, technique, or arrangement for achieving a function or result, any alternative means, mechanism, component, material, technique, or arrangement that achieves the same function or result in a substantially similar way is within the scope of the disclosure. This statement of functional equivalence is consistent with the Doctrine of Equivalents and is provided to inform claim construction. It does not expand the claims beyond their proper scope but rather clarifies that the specification supports a range of implementations, not solely the specific embodiments illustrated. For the avoidance of doubt, this provision encompasses achieving the described stabilization function using stabilization elements other than those expressly described, achieving the described electrical connection function using connector types other than those expressly described, achieving the described power conditioning function using converter topologies other than those expressly described, and deploying flexible photovoltaic sheets made from perovskite formulations other than those expressly described.

Unless expressly stated otherwise in a particular claim or required by the inherent logic of the recited operations, the steps of any method claim need not be performed in the order in which they are recited. Different steps may be performed simultaneously, in overlapping time periods, or in any order that achieves the stated result. For example, the deploying, stabilizing, disconnecting, and connecting steps described in the method 100 shown in FIG. 1 and the method 200 shown in FIG. 2 may be performed in different sequences depending on the operational requirements of a particular solar cell module farm installation. The disconnecting of an extant solar cell module from the solar cell module farm wiring may occur before, during, or after the deploying and stabilizing steps. The connecting of the flexible perovskite solar cell module sheet into the solar cell module farm wiring may occur before or after stabilization is complete. The specification describes particular sequences for clarity of exposition, and those sequences are illustrative rather than mandatory unless a claim explicitly requires a particular order.

Furthermore, the methods described herein may be implemented using the assemblies and systems described herein, and the assemblies and systems described herein may be used to perform operations other than those expressly described in connection with particular embodiments. The method claims and apparatus claims in this disclosure represent independent categories of invention. No feature or element is essential to each and every embodiment of the invention. An apparatus claim reciting structural elements does not require performance of any particular method, and a method claim reciting steps does not require use of any particular apparatus, unless expressly stated in the claim.

As used herein, the term “processor” refers to any computing entity capable of executing instructions or performing operations, whether implemented in hardware, firmware, software, or any combination thereof. The term encompasses, without limitation: general-purpose processors (CPUs), graphics processing units (GPUs), digital signal processors (DSPs), application-specific integrated circuits (ASICs), field-programmable gate arrays (FPGAs), neural processing units (NPUs), tensor processing units (TPUs), system-on-chip (SoC) designs, multi-core processors, co-processors, microcontrollers, embedded processors, cloud-based and virtualized processing resources, edge computing devices, and any future processing technology. The term “processor” also encompasses the associated memory and storage components (including registers, cache, RAM, persistent storage) that operate in conjunction with the processing unit. Where the specification refers to “the processor 810” or “the processing system 1308,” these terms describe functional computing components and do not require that the processing be performed by a single physical device. A single computing system may perform all described processing functions, or the processing functions may be distributed across multiple devices connected by wired or wireless communication links.

As used herein, the terms “memory,” “storage,” “store,” “storing,” and variants thereof refer to any mechanism, medium, device, or system for recording, retaining, and retrieving data in any format. These terms encompass volatile memory (such as SRAM and DRAM), non-volatile memory (such as flash memory, EEPROM, and magnetoresistive RAM), persistent storage (such as solid-state drives, hard disk drives, and optical media), distributed storage (such as network-attached storage, storage area networks, and cloud storage), in-memory data structures, database systems, and any emerging storage technology. The terms do not imply any particular duration of data retention, any particular storage technology, or any particular access pattern unless explicitly stated. Where the specification refers to “the memory 812” or “the configuration database 870,” these terms describe functional data storage components and do not require any particular storage technology or architecture.

The algorithmic analysis described in connection with the system 800 shown in FIG. 8 and the AI configuration control system 1300 shown in FIG. 13, including the module assessment 830, the sheet configuration 840, and the wiring configuration 850, may be implemented using any suitable computational methodology. The term “AI” as used in the specification refers broadly to any automated decision-making, optimization, or analysis technique and does not require any particular form of artificial intelligence, machine learning architecture, or algorithm. The described algorithmic functions may be implemented using, without limitation: machine learning models (including neural networks of any architecture, decision trees, random forests, gradient-boosted models, support vector machines, Bayesian networks, and reinforcement learning agents); rule-based expert systems and decision-table approaches; mathematical optimization algorithms (including linear programming, mixed-integer programming, quadratic programming, convex optimization, genetic algorithms, simulated annealing, particle swarm optimization, and ant colony optimization); statistical models and regression analysis; heuristic and metaheuristic approaches; lookup tables and interpolation methods; deterministic algorithms with defined decision criteria; or any combination thereof. The instructions stored in the memory may be embodied as software, firmware, or a combination of software and hardware. The system 800 and the AI configuration control system 1300 may be implemented as cloud-based computing systems, edge computing systems, distributed computing systems, embedded computing systems, mobile computing systems, or combinations thereof.

As used herein, the terms “network,” “communication channel,” “channel,” “link,” and variants thereof refer to any medium, mechanism, or infrastructure for conveying data between two or more entities. These terms encompass wired and wireless networks, local area networks and wide area networks, the internet, intranets, cellular networks, satellite links, radio links, optical links and fiber-optic channels, power-line communication, and any combination thereof. Where the specification describes transmitting operational data, deployment plans, configuration parameters, or monitoring data between components of the system 800 or the AI configuration control system 1300, any communication mechanism suitable for conveying the described data is encompassed.

As used herein, the term “non-transitory computer-readable medium” or “computer-readable storage medium” refers to any tangible medium that stores instructions or data accessible by a processor, including but not limited to semiconductor memory, magnetic storage, optical storage, and any other non-transitory medium. This term explicitly excludes transitory signals per se but includes any physical medium on which data may be stored.

The methods, systems, and assemblies described herein provide specific, concrete, and tangible improvements to solar energy generation systems, photovoltaic module deployment, and solar cell module farm lifecycle management. The disclosed technology addresses a specific technical problem in the field of renewable energy infrastructure: the challenge of extending the productive life of aging solar cell module farms without requiring complete decommissioning, removal of existing infrastructure, and replacement with new installations. The disclosed solution involves the physical deployment of lightweight flexible perovskite photovoltaic devices directly onto the surfaces of existing solar cell modules, leveraging the existing physical support infrastructure, and integrating the deployed devices into the existing electrical wiring of the solar cell module farm.

The described methods and assemblies effect a physical transformation of existing solar energy infrastructure from a degraded or aging state to a repowered state, resulting in the concrete, practical result of restored or increased electrical energy generation from the repowered solar cell module positions within the farm. The physical operations described herein, including the deployment of flexible sheets onto rigid surfaces, the application of stabilization elements to secure physical components, the disconnection and reconnection of electrical wiring, and the conditioning of electrical output, are tangible operations performed on physical structures and physical electrical systems. The algorithmic analysis described in connection with the system 800 and the AI configuration control system 1300 is integrated into and drives specific physical deployment actions, including the physical deployment of flexible perovskite solar cell module sheets, the physical reconfiguration of electrical wiring, and the physical transformation of solar cell module farm infrastructure, and is not recited as an abstract analytical exercise.

Features described in connection with one embodiment may be combined with features described in connection with any other embodiment unless such combination is structurally infeasible or expressly excluded. Sub-combinations of disclosed features are within the scope of the disclosure. For example, the stabilization approaches described in connection with the deactivated panel assembly 900 (including adhesive, mechanical attachment, and removable attachment) may be combined with any of the electrical connection configurations described in connection with the multi-sheet wiring topology 1100 or the PECI integration schematic 1200. The partial coverage configuration described in connection with the solar cell system 500 shown in FIG. 5 may be combined with the tandem wavelength-selective operation described in connection with the tandem solar cell assembly 600 shown in FIG. 6. The AI-based configuration system described in connection with FIGS. 8 and 13 may be used to plan and control deployments using any of the physical deployment, stabilization, and electrical connection approaches described elsewhere in the specification. Any such combination falls within the scope of the present disclosure.

Persons of ordinary skill in the art will appreciate that the present disclosure encompasses variations beyond those expressly described. The following non-exhaustive identification of alternative implementations is provided to document the scope of contemplated variations:

The flexible perovskite solar cell module sheet is not limited to the particular perovskite compositions, layer structures, or cell architectures described in connection with the perovskite solar cell 700 shown in FIG. 7. Alternative implementations include: perovskite formulations using cesium-only A-site cations, triple-cation formulations, formamidinium-rich compositions, or compositions incorporating rubidium or guanidinium; lead-free perovskite compositions using tin, germanium, bismuth, or antimony at the B-site; alternative hole transport materials including spiro-OMeTAD, PTAA, P3HT, CuSCN, CuI, and other p-type semiconductors in addition to or in place of the nickel oxide described in connection with the hole transport layer 730; alternative electron transport materials including titanium dioxide, zinc oxide, PCBM, C60, and other n-type semiconductors in addition to or in place of the tin oxide described in connection with the electron transport layer 770; alternative transparent conductive materials including fluorine-doped tin oxide, aluminum-doped zinc oxide, silver nanowire networks, carbon nanotube networks, graphene-based electrodes, and conductive polymers in addition to or in place of the transparent conductive oxide 780; alternative substrate materials including polyethylene terephthalate, polyethylene naphthalate, polyimide, stainless steel foil, and other flexible substrate materials; and alternative encapsulation approaches including atomic layer deposition barriers, polymer encapsulation, glass-polymer lamination, and edge-seal encapsulation.

The stabilization element is not limited to silicone sealant adhesives, mounting brackets, screws with washers, framing brackets, and Velcro strips, and may include: alternative adhesive materials such as butyl rubber tape, ethylene-vinyl acetate lamination, thermoplastic polyolefin adhesives, and structural acrylics; alternative mechanical attachment approaches such as spring clips, channel-and-rail systems, and interlocking edge profiles; magnetic attachment systems using embedded magnets or ferromagnetic mounting surfaces; and any other attachment mechanism that secures a flexible sheet in contact with a rigid surface.

The electrical connections are not limited to MC4, MC3, T4, and H4 connectors and may include other connector types used in photovoltaic installations, direct-wire connections using solder, crimp, or compression terminations, wireless power transfer, and any other means of establishing electrical connectivity.

The extant solar cell module is not limited to crystalline silicon modules and may include any photovoltaic technology as defined in the section titled “Photovoltaic and Solar Energy Terminology” above.

The external power conditioning device is not limited to the particular converter topologies described herein and may include alternative DC-DC converter architectures, resonant converters, switched-capacitor converters, maximum power point tracking optimizers, module-level power electronics of any topology, and other power conditioning circuitry known in the art.

The AI configuration and control system is not limited to the specific input data types, processing architectures, or output formats described in connection with FIGS. 8 and 13. Alternative implementations may use different combinations of input data, different algorithmic approaches as described in the section titled “Algorithmic Implementations” above, and different output formats including graphical displays, printed work orders, digital instructions transmitted to mobile devices, and automated control signals transmitted directly to deployment equipment.

All patents, patent applications, and publications cited or referenced in this specification are incorporated herein by reference in their entirety for all purposes to the extent permitted by applicable law. U.S. Provisional Application No. 63/777,788, filed Mar. 26, 2025, is incorporated herein by reference in its entirety for all purposes.

The methods, systems, and assemblies described herein involve the physical deployment, attachment, and electrical integration of photovoltaic devices onto existing solar energy infrastructure, and the physical transformation of solar cell module farms from a degraded state to a repowered state. These are technical solutions to technical problems in the field of renewable energy systems and involve the manipulation of physical structures and physical electrical systems to achieve concrete technical results.

To the extent that any term or phrase used herein has a different customary meaning in different jurisdictions, the term or phrase is to be given its broadest reasonable interpretation consistent with the specification in the jurisdiction in which protection is sought.

Section headings used in this specification are for organizational convenience only and are not to be construed as limiting the subject matter described. Reference numerals used in the specification and drawings are for identification purposes and do not imply a required sequence, hierarchy, or relative importance among the identified elements. The use of the same reference numeral in different figures indicates that the element serves the same or an analogous function in each figure unless the context clearly indicates otherwise.

The foregoing descriptions of specific embodiments are presented for purposes of illustration and description. They are not intended to be exhaustive or to limit the invention to the precise forms disclosed. Many modifications, variations, and alternative implementations will be apparent to practitioners skilled in the art in light of the above teaching. The embodiments were chosen and described to explain the principles of the invention and its practical application, to thereby enable others skilled in the art to make and use the invention and various embodiments with various modifications as are suited to the particular use contemplated.

The scope of the invention is not limited to the specific embodiments, materials, compositions, layer structures, connector types, stabilization mechanisms, converter topologies, algorithmic approaches, wiring configurations, or implementation details described in the specification. The claims are to be interpreted according to their terms and in view of the specification, encompassing all equivalents to which such claims are entitled.

Elements, features, and steps described in the context of one embodiment may be omitted, combined with elements from other embodiments, or rearranged in different configurations, unless such omission, combination, or rearrangement would be understood by a person of ordinary skill in the art as fundamentally incompatible with the described function. The inclusion of specific numerical examples (such as the bend radius range of 5 centimeters to 50 centimeters, the identification of 60-cell, 72-cell, or 96-cell panel formats, the listing of specific connector types, or the identification of specific perovskite layer materials), specific physical configurations, specific material compositions, or specific implementation details is illustrative and not limiting. Accordingly, other implementations are within the scope of the following claims.

A number of implementations have been described. Nevertheless, it will be understood that various modifications may be made without departing from the spirit and scope of the disclosure. Accordingly, other implementations are within the scope of the following claims.

1. A solar cell module repowering assembly comprising:
a first flexible perovskite solar cell module sheet configured for deployment directly on a surface of an extant solar cell module, wherein the first flexible perovskite solar cell module sheet has a weight sufficiently low that physical support structures supporting the extant solar cell module support both the extant solar cell module and the first flexible perovskite solar cell module sheet without structural reinforcement, and wherein the extant solar cell module comprises one or more of a functional, degraded, failing, or failed solar cell module;
a stabilization element configured to stabilize the first flexible perovskite solar cell module sheet on the extant solar cell module, wherein the stabilization element secures the first flexible perovskite solar cell module sheet in direct contact with a surface of the extant solar cell module;
wherein the extant solar cell module provides mechanical support for the first flexible perovskite solar cell module sheet; and
wherein physical support structures supporting the extant solar cell module support both the extant solar cell module and the first flexible perovskite solar cell module sheet without structural modification; and
electrical connections configured to connect the first flexible perovskite solar cell module sheet into a solar cell module farm wiring.

2. The assembly of claim 1, wherein the first flexible perovskite solar cell module sheet is produced in a roll format having a bend radius between 5 centimeters and 50 centimeters, and wherein the first flexible perovskite solar cell module sheet is configured to be unrolled flat for deployment directly onto the surface of the extant solar cell module.

3. The assembly of claim 1, wherein the first flexible perovskite solar cell module sheet is precut to fit atop the extant solar cell module, and wherein precut dimensions of the first flexible perovskite solar cell module sheet match dimensions of the extant solar cell module.

4. The assembly of claim 1, wherein the first flexible perovskite solar cell module sheet is field cut to fit atop the extant solar cell module on site to accommodate one or more of varying panel sizes across a solar cell module farm, irregular panel shapes, and damaged panels.

5. The assembly of claim 1, wherein the stabilization element comprises a silicone sealant adhesive configured to be applied between the first flexible perovskite solar cell module sheet and the extant solar cell module, and wherein the silicone sealant adhesive enables direct contact between the first flexible perovskite solar cell module sheet and the surface of the extant solar cell module.

6. The assembly of claim 1, wherein the stabilization element comprises mechanical attachment comprising one or more of mounting brackets, screws with washers, and framing brackets, and wherein the mechanical attachment is configured to adjust existing mounting brackets to hold both the extant solar cell module and the first flexible perovskite solar cell module sheet.

7. The assembly of claim 1, wherein the electrical connections are configured to occupy an electrical position in the solar cell module farm wiring, the electrical position being a position previously occupied by the extant solar cell module prior to disconnection of the extant solar cell module from the solar cell module farm wiring, and wherein the electrical connections comprise connectors compatible with existing farm wiring connectors comprising one or more of MC4, MC3, T4, and H4 connectors.

8. The assembly of claim 1, further comprising a second flexible perovskite solar cell module sheet configured for deployment over an additional extant solar cell module, wherein the first flexible perovskite solar cell module sheet and the second flexible perovskite solar cell module sheet define distinct solar energy collection regions when deployed, and wherein the first flexible perovskite solar cell module sheet and the second flexible perovskite solar cell module sheet are configured for progressive deployment across a solar cell module farm.

9. The assembly of claim 8, wherein the distinct solar energy collection regions are configured to form a contiguous solar energy collection region across the extant solar cell module and the additional extant solar cell module, and wherein the extant solar cell module and the additional extant solar cell module are adjacent extant solar cell modules forming a continuous solar energy collection surface.

10. The assembly of claim 8, wherein the second flexible perovskite solar cell module sheet is configured for serial connection with the first flexible perovskite solar cell module sheet, and wherein the serial connection increases voltage output of combined first and second flexible perovskite solar cell module sheets to form a string.

11. The assembly of claim 8, wherein the second flexible perovskite solar cell module sheet is configured for parallel connection with the first flexible perovskite solar cell module sheet, and wherein the parallel connection increases current output while maintaining voltage at an individual sheet level.

12. The assembly of claim 1, further comprising an external power conditioning device configured to be positioned between the first flexible perovskite solar cell module sheet and the solar cell module farm wiring, wherein the first flexible perovskite solar cell module sheet is configured to provide a voltage and current output, and wherein the external power conditioning device is configured to perform one or more of voltage step-up, voltage step-down, and current limiting, and wherein the external power conditioning device is configurable to match one of a plurality of predefined electrical profiles corresponding to different inverter types.

13. A method for repowering a solar cell module, the method comprising:
deploying a first flexible perovskite solar cell module sheet over an extant solar cell module in a solar cell module farm, wherein the first flexible perovskite solar cell module sheet has a weight sufficiently low that physical support structures supporting the extant solar cell module support both the extant solar cell module and the first flexible perovskite solar cell module sheet without structural reinforcement, wherein the extant solar cell module comprises one or more of a functional, degraded, failing, or failed solar cell module, wherein the first flexible perovskite solar cell module sheet is deployed directly on a surface of the extant solar cell module, and wherein the solar cell module farm continues to provide electrical energy from non-repowered extant solar cell modules during the deploying;
stabilizing the first flexible perovskite solar cell module sheet on the extant solar cell module using a stabilization element, wherein the stabilization element secures the first flexible perovskite solar cell module sheet in direct contact with a surface of the extant solar cell module;
wherein the extant solar cell module provides mechanical support for the first flexible perovskite solar cell module sheet; and
wherein physical support structures supporting the extant solar cell module continue to support both the extant solar cell module and the first flexible perovskite solar cell module sheet without structural modification;
connecting electrically the first flexible perovskite solar cell module sheet into solar cell module farm wiring; and
providing electrical energy using the first flexible perovskite solar cell module sheet and the solar cell module farm wiring.

14. The method of claim 13, wherein the first flexible perovskite solar cell module sheet is produced in a roll format having a bend radius between 5 centimeters and 50 centimeters enabling transport in a rolled configuration, wherein the first flexible perovskite solar cell module sheet is one of precut or field cut to fit atop the extant solar cell module, and wherein the first flexible perovskite solar cell module sheet is transported in compact rolls and unrolled directly onto the surface of the extant solar cell module.

15. The method of claim 13, wherein the stabilizing comprises one or more of applying a silicone sealant adhesive between the first flexible perovskite solar cell module sheet and the extant solar cell module, mechanically attaching the first flexible perovskite solar cell module sheet to the extant solar cell module using one or more of mounting brackets, screws with washers, and framing brackets, and removable attachment comprising Velcro strips, and wherein the stabilizing enables direct contact between the first flexible perovskite solar cell module sheet and the surface of the extant solar cell module.

16. The method of claim 13, further comprising disconnecting the extant solar cell module from the solar cell module farm wiring, wherein the extant solar cell module is electrically deactivated and no longer provides electrical energy, wherein the extant solar cell module remains in place as a structural mount for the first flexible perovskite solar cell module sheet, wherein the first flexible perovskite solar cell module sheet occupies an electrical position in the solar cell module farm wiring previously occupied by the extant solar cell module, and wherein the disconnecting comprises one or more of disconnecting output wiring at a junction box of the extant solar cell module and disconnecting connectors of the extant solar cell module from string wiring, and wherein disconnected connectors are capped.

17. The method of claim 13, further comprising:
deploying a second flexible perovskite solar cell module sheet over an additional extant solar cell module;
stabilizing the second flexible perovskite solar cell module sheet on the additional extant solar cell module, wherein the stabilizing enables distinct solar energy collection regions between the first flexible perovskite solar cell module sheet and the second flexible perovskite solar cell module sheet; and
interconnecting the second flexible perovskite solar cell module sheet into the solar cell module farm wiring, wherein the deploying of the second flexible perovskite solar cell module sheet is part of a progressive deployment across the solar cell module farm, and wherein the solar cell module farm continues to produce electrical energy from non-repowered extant solar cell modules during the progressive deployment.

18. The method of claim 17, wherein the interconnecting comprises one of a serial connection, a parallel connection, or a mixed series-parallel configuration between the first flexible perovskite solar cell module sheet and the second flexible perovskite solar cell module sheet, wherein the serial connection increases voltage and the parallel connection increases current.

19. The method of claim 13, wherein the connecting electrically comprises conditioning an electrical output of the first flexible perovskite solar cell module sheet to match an operating envelope of an existing inverter within the solar cell module farm wiring, wherein the conditioning comprises one or more of voltage step-up, voltage step-down, current limiting, and output stabilization, and wherein the conditioning is performed by an external power conditioning device positioned between the first flexible perovskite solar cell module sheet and the solar cell module farm wiring.

20. The method of claim 13, wherein the connecting electrically comprises reusing one or more existing inverters within the solar cell module farm wiring, and wherein the first flexible perovskite solar cell module sheet is configured to match voltage and current specifications of the extant solar cell module, enabling the one or more existing inverters to continue operating within designed input windows, and wherein the first flexible perovskite solar cell module sheet comprises internal cell wiring in one or more of a series configuration and a parallel configuration to match the voltage and current specifications of the extant solar cell module.
